(19) United States
(12) Patent Application Publication
(10) Pub. No.: US 2024/0373143 A1
(43) Pub. Date: Nov. 7, 2024

(54) SOLID-STATE IMAGING ELEMENT, IMAGING DEVICE, AND SOLID-STATE IMAGING ELEMENT CONTROL METHOD

(71) Applicant: Sony Semiconductor Solutions Corporation, Kanagawa (JP)

(72) Inventors: Hiromu Kato, Kanagawa (JP); Luonghung Asakura, Kanagawa (JP); Yoshiaki Inada, Tokyo (JP)

(21) Appl. No.: 18/685,676

(22) PCT Filed: Aug. 17, 2022
(86) PCT No.: PCT/JP2022/031020

§ 371 Date: Feb. 22, 2024

(30) Foreign Application Priority Data
Oct. 15, 2021 (JP) 2021-169355

(51) Int. Cl. H04N 25/532; H04N 25/616; H04N 25/65; H04N 25/709; H04N 25/77; H04N 25/79

(52) U.S. Cl. CPC H04N 25/532; H04N 25/616; H04N 25/65; H04N 25/709; H04N 25/77; H04N 25/79

(57) ABSTRACT

To improve the image quality in a solid-state imaging element that performs exposure by a rolling shutter scheme or a global shutter scheme.

A pixel circuit outputs a pixel signal as an input signal and, in a case where a rolling shutter mode to start exposure sequentially row by row is selected, outputs the pixel signal as a first output signal. A sample-hold circuit holds the input signal and outputs the input signal as a second output signal in a case where a global shutter mode to start exposure simultaneously for all pixels is selected. A changeover switch selects any one of the first and second output signals and outputs the selected one to an analog-to-digital converter.

### TECHNICAL FIELD

The present technology relates to a solid-state imaging element. Specifically, the present technology relates to a solid-state imaging element, an imaging device, and a solid-state imaging element control method that perform column-by-column AD (Analog to Digital) conversion.

### BACKGROUND ART

There has been a conventionally-used column ADC (Analog to Digital Converter) scheme in which, in a solid-state imaging element, for the purpose of miniaturizing pixels, an ADC is arranged for each column outside a pixel array section and pixel signals are read out sequentially row by row. There is a proposed solid-state imaging element in which a pair of capacitances are provided for each pixel and are caused to hold a reset level and a signal level, in order to realize a global shutter scheme in the column ADC scheme (e.g., refer to NPL 1).

### CITATION LIST

### Non Patent Literature

### [NPL 1]

Jae-kyu Lee, et al., A 2.1e-Temporal Noise and −105 dB Parasitic Light Sensitivity Backside-Illuminated 2.3 μm-Pixel Voltage-Domain Global Shutter CMOS Image Sensor Using High-Capacity DRAM Capacitor Technology, ISSCC 2020.

### Summary

### Technical Problem

The conventional technology described above attempts to realize the global shutter scheme in the column ADC scheme by causing the pair of capacitances to hold the reset level and the signal level for each pixel. However, there is a problem that, in a case where a rolling shutter scheme is used, kTC noise is generated in circuits that sample-hold signals and, due to the noise, the image quality of image data lowers undesirably.

The present technology has been produced in view of such a situation, and an object thereof is to improve the image quality in a solid-state imaging element that performs exposure by a rolling shutter scheme or a global shutter scheme.

### Solution to Problem

The present technology has been made to solve the problem described above, and a first aspect thereof is a solid-state imaging element including a pixel circuit that outputs a pixel signal as an input signal and, in a case where a rolling shutter mode to start exposure sequentially row by row is selected, outputs the pixel signal as a first output signal, a sample-hold circuit that holds the input signal and outputs the input signal as a second output signal in a case where a global shutter mode to start exposure simultaneously for all pixels is selected, and a changeover switch that selects any one of the first and second output signals and outputs the selected one to an analog-to-digital converter, and a control method thereof. This gives an effect that the image quality is improved when exposure is performed by a rolling shutter scheme.

In addition, in the first aspect, the solid-state imaging element may further include a current supply switch that connects a first vertical signal line to a predetermined power supply voltage in the case where the global shutter mode is selected and that connects the first vertical signal line to the changeover switch in the case where the rolling shutter mode is selected. The pixel circuit may output the first output signal via the first vertical signal line, and the sample-hold circuit may output the second output signal via a second vertical signal line. This gives an effect that the sunspot phenomenon is prevented.

In addition, in the first aspect, the pixel circuit may include first and second photoelectric converting elements, a first transfer transistor that transfers a charge from the first photoelectric converting element to a floating diffusion layer, a second transfer transistor that transfers a charge from the second photoelectric converting element to the floating diffusion layer, a first reset transistor that initializes the floating diffusion layer, an upstream amplification transistor that outputs, as the input signal, a pixel signal obtained by amplifying a voltage of the floating diffusion layer to a predetermined upstream node in the sample-hold circuit, and a selection transistor that outputs, as the first output signal, the pixel signal according to a predetermined control signal. This gives an effect that the circuit scale per pixel is reduced.

In addition, in the first aspect, the pixel circuit may include a photoelectric converting element, a transfer transistor that transfers a charge from the photoelectric converting element to a floating diffusion layer, a first reset transistor that initializes the floating diffusion layer, an upstream amplification transistor that outputs, as the input signal, a pixel signal obtained by amplifying a voltage of the floating diffusion layer to a predetermined upstream node in the sample-hold circuit, and a selection transistor that outputs, as the first output signal, the pixel signal according to a predetermined control signal. This gives an effect that the pixel signal is generated.

In addition, in the first aspect, the solid-state imaging element may further include a vertical scanning circuit that supplies a predetermined clip level to a gate of the selection transistor when the global shutter mode is selected and a predetermined reset level is held at the sample-hold circuit. This gives an effect that the reset level is clipped.

In addition, in the first aspect, the pixel signal may include a predetermined reset level and a signal level according to an exposure amount, and the sample-hold circuit may include first and second capacitive elements, a selecting circuit that sequentially performs control to connect one of the first and second capacitive elements to a predetermined downstream node, control to disconnect both the first and second capacitive elements from the downstream node, and control to connect the other of the first and second capacitive elements to the downstream node, a downstream reset transistor that initializes a level of the downstream node when both the first and second capacitive elements are disconnected from the downstream node, and a downstream circuit that sequentially reads out and outputs the reset level and the signal level from the first and second capacitive elements via the downstream node. This gives an effect that kTC noise is reduced.

In addition, in the first aspect, the solid-state imaging element may further include a switching section that adjusts a source voltage to be supplied to a source of the upstream amplification transistor. The sample-hold circuit may further include a current source transistor connected to a drain of the upstream amplification transistor, and the current source transistor may transition from an ON state to an OFF state after an end of an exposure period. This gives an effect that an upstream source follower is switched to the OFF state at the time of readout.

In addition, in the first aspect, the pixel circuit may further include a discharge transistor that discharges the charge from the photoelectric converting element. This gives an effect that the photoelectric converting element is initialized.

In addition, in the first aspect, the solid-state imaging element may further include a control circuit that controls a reset power supply voltage. The first reset transistor may initialize a voltage of a floating diffusion layer to the reset power supply voltage, and, in a readout period in which the reset level and the signal level are read out, the control circuit may make the reset power supply voltage a voltage different from a voltage in an exposure period. This gives an effect that the photo response non-uniformity is ameliorated.

In addition, in the first aspect, the solid-state imaging element may further include a digital signal processing section that adds together a pair of consecutive frames. In an exposure period of one of the pair of frames, the sample-hold circuit may cause one of the first and second capacitive elements to hold the reset level and thereafter cause the other of the first and second capacitive elements to hold the signal level, and, in an exposure period of the other of the pair of frames, the sample-hold circuit may cause the other of the first and second capacitive elements to hold the reset level and thereafter cause the one of the first and second capacitive elements to hold the signal level. This gives an effect that the photo response non-uniformity is ameliorated.

In addition, in the first aspect, the solid-state imaging element may further include an analog-to-digital converter that converts the output reset level and signal level sequentially into digital signals. This gives an effect that digital image data is generated.

In addition, in the first aspect, the analog-to-digital converter may include a comparator that compares a level of a vertical signal line which transfers the reset level and the signal level and a predetermined ramp signal and that outputs a comparison result, and a counter that performs counting with a count over a period until the comparison result is inverted and that outputs the digital signal representing the count. This gives an effect that analog-to-digital conversion is realized with a simple configuration.

In addition, in the first aspect, the comparator may include a comparing section that compares levels of a pair of input terminals and outputs a comparison result, and an input side selector that selects any one of the vertical signal line and a node with a predetermined reference voltage and connects the selected one to one of the pair of input terminals, and the ramp signal may be input to one of the pair of input terminals. This gives an effect that the sunspot phenomenon is suppressed.

In addition, in the first aspect, the solid-state imaging element may further include a control section that determines whether or not illuminance is higher than a predetermined value on the basis of the comparison result and that outputs a determination result, a CDS (Correlated Double Sampling) processing section that executes a correlated double sampling process on the digital signal, and an output side selector that outputs any of the digital signal on which the correlated double sampling process has been executed and a digital signal with a predetermined value, on the basis of the determination result. This gives an effect that the sunspot phenomenon is suppressed.

In addition, in the first aspect, the pixel circuit may be provided on a first chip, and the sample-hold circuit may be provided on a second chip. This gives an effect that miniaturization of pixels becomes easier.

In addition, a second aspect of the present technology is a solid-state imaging element including first and second capacitive elements, each of which has one end which shares a connection to a predetermined upstream node, a pixel circuit that sequentially generates a predetermined reset level and a signal level according to an exposure amount and outputs the predetermined reset level and the signal level to the upstream node, a selecting circuit that connects the other end of any one of the first and second capacitive elements to a predetermined downstream node, a downstream circuit that sequentially reads out the reset level and the signal level from the first and second capacitive elements via the downstream node and outputs the reset level and the signal level via a predetermined vertical signal line, and a bypass transistor that connects the upstream node and the vertical signal line in a case where a rolling shutter mode to start exposure sequentially row by row is selected. This gives an effect that the image quality is improved when exposure is performed by a rolling shutter scheme by bypassing.

In addition, a third aspect of the present technology is an imaging device including a pixel circuit that outputs a pixel signal as an input signal and, in a case where a rolling shutter mode to start exposure sequentially row by row is selected, outputs the pixel signal as a first output signal, a sample-hold circuit that holds the input signal and outputs the input signal as a second output signal in a case where a global shutter mode to start exposure simultaneously for all pixels is selected, a changeover switch that selects any one of the first and second output signals and outputs the selected one as an analog signal, and an analog-to-digital converter that converts the analog signal into a digital signal. This gives an effect that the image quality is improved when exposure is performed in the imaging device by a rolling shutter scheme.

### BRIEF DESCRIPTION OF DRAWINGS

FIG. 1 is a block diagram depicting a configuration example of an imaging device in a first embodiment of the present technology.

FIG. 2 is a block diagram depicting a configuration example of a solid-state imaging element in the first embodiment of the present technology.

FIG. 3 is a circuit diagram depicting a configuration example of a pixel in the first embodiment of the present technology.

FIG. 4 is a block diagram depicting configuration examples of a column signal processing circuit and a load MOS circuit block in the first embodiment of the present technology.

FIG. 5 is a timing chart depicting an example of a global shutter operation in the first embodiment of the present technology.

FIG. 6 is a timing chart depicting an example of a readout operation in the first embodiment of the present technology.

FIG. 7 is a timing chart depicting another example of the readout operation in the first embodiment of the present technology.

FIG. 8 is a circuit diagram depicting a configuration example of a pixel in a comparative example.

FIG. 9 is a figure depicting examples of a state of the pixel at the time of reset-level readout and a state of the pixel at the time of initialization of a downstream node in the first embodiment of the present technology.

FIG. 10 is a figure depicting an example of a state of the pixel at the time of signal-level readout in the first embodiment of the present technology.

FIG. 11 is a flowchart depicting an example of an operation of the solid-state imaging element in the first embodiment of the present technology.

FIG. 12 is a circuit diagram depicting a configuration example of the pixel in a first modification example of the first embodiment of the present technology.

FIG. 13 is a timing chart depicting an example of the global shutter operation in the first modification example of the first embodiment of the present technology.

FIG. 14 is a timing chart depicting an example of the readout operation in the first modification example of the first embodiment of the present technology.

FIG. 15 is a figure depicting an example of a stacked structure of the solid-state imaging element in a second modification example of the first embodiment of the present technology.

FIG. 16 is a circuit diagram depicting a configuration example of the pixel in the second modification example of the first embodiment of the present technology.

FIG. 17 is a figure depicting an example of the stacked structure of the solid-state imaging element in a third modification example of the first embodiment of the present technology.

FIG. 18 is a circuit diagram depicting a configuration example of the pixel in a second embodiment of the present technology.

FIG. 19 is a timing chart depicting an example of the global shutter operation in the second embodiment of the present technology.

FIG. 20 is a circuit diagram depicting a configuration example of the pixel in a third embodiment of the present technology.

FIG. 21 is a figure for explaining a reset feedthrough in the third embodiment of the present technology.

FIG. 22 is a figure for explaining variations of levels caused by the reset feedthrough in the third embodiment of the present technology.

FIG. 23 is a timing chart depicting an example of voltage control in the third embodiment of the present technology.

FIG. 24 is a timing chart depicting an example of the global shutter operation on an odd-numbered frame in a fourth embodiment of the present technology.

FIG. 25 is a timing chart depicting an example of the readout operation on an odd-numbered frame in the fourth embodiment of the present technology.

FIG. 26 is a timing chart depicting an example of the global shutter operation on an even-numbered frame in the fourth embodiment of the present technology.

FIG. 27 is a timing chart depicting an example of the readout operation on an even-numbered frame in the fourth embodiment of the present technology.

FIG. 28 is a circuit diagram depicting a configuration example of the column signal processing circuit in a fifth embodiment of the present technology.

FIG. 29 is a timing chart depicting an example of the global shutter operation in the fifth embodiment of the present technology.

FIG. 30 is a timing chart depicting an example of the readout operation in the fifth embodiment of the present technology.

FIG. 31 is a timing chart depicting an example of a rolling shutter operation in a sixth embodiment of the present technology.

FIG. 32 is a block diagram depicting a configuration example of the solid-state imaging element in a seventh embodiment of the present technology.

FIG. 33 is a circuit diagram depicting a configuration example of a dummy pixel, a regulator, and a switching section in the seventh embodiment of the present technology.

FIG. 34 is a timing chart depicting an example of operations of a dummy pixel and the regulator in the seventh embodiment of the present technology.

FIG. 35 is a circuit diagram depicting a configuration example of an effective pixel in the seventh embodiment of the present technology.

FIG. 36 is a timing chart depicting an example of the global shutter operation in the seventh embodiment of the present technology.

FIG. 37 is a timing chart depicting an example of the readout operation in the seventh embodiment of the present technology.

FIG. 38 is a figure for explaining effects in the seventh embodiment of the present technology.

FIG. 39 is a circuit diagram depicting configuration examples of the pixel and the load MOS circuit block in an eighth embodiment of the present technology.

FIG. 40 is a figure depicting the states of the pixel and the load MOS circuit block in a rolling shutter mode in the eighth embodiment of the present technology.

FIG. 41 is a timing chart depicting an example of an operation of the solid-state imaging element in the rolling shutter mode in the eighth embodiment of the present technology.

FIG. 42 is a figure depicting the states of a pixel and the load MOS circuit block in a global shutter mode in the eighth embodiment of the present technology.

FIG. 43 is a timing chart depicting an example of an operation of the solid-state imaging element in the global shutter mode in the eighth embodiment of the present technology.

FIG. 44 is a figure depicting an example of an inter-chip connection state in the eighth embodiment of the present technology.

FIG. 45 is a circuit diagram depicting a configuration example of the pixel block in a modification example of the eighth embodiment of the present technology.

FIG. 46 is a circuit diagram depicting a configuration example of the pixel in a ninth embodiment of the present technology.

FIG. 47 is a figure for comparing the sixth, eighth, and ninth embodiments of the present technology.

FIG. 48 is a block diagram depicting an example of schematic configuration of a vehicle control system.

FIG. 49 is a diagram of assistance in explaining an example of installation positions of an outside-vehicle information detecting section and an imaging section.

### DESCRIPTION OF EMBODIMENTS

Hereinbelow, modes for carrying out the present technology (hereinafter, referred to as embodiments) are explained. The explanation is given in the following order.
1. First Embodiment (example in which first and second capacitive elements are caused to hold pixel signals)
2. Second Embodiment (example in which discharge transistor is added and first and second capacitive elements are caused to hold pixel signals)
3. Third Embodiment (example in which first and second capacitive elements are caused to hold pixel signals and reset power supply voltage is controlled)
4. Fourth Embodiment (example in which first and second capacitive elements are caused to hold pixel signals and levels to be held are switched from one to another for each frame)
5. Fifth Embodiment (example in which first and second capacitive elements are caused to hold pixel signals and sunspot phenomenon is suppressed)
6. Sixth Embodiment (example in which first and second capacitive elements are caused to hold pixel signals and rolling shutter operation is performed)
7. Seventh Embodiment (example in which first and second capacitive elements are caused to hold pixel signals and upstream source follower is switched to OFF state at time of readout)
8. Eighth Embodiment (example in which output from pixel circuit and output from sample-hold circuit are switched from one to the other)
9. Ninth Embodiment (example in which upstream node and vertical signal line are bypass-connected)
10. Examples of Application to Mobile Bodies

### 1. First Embodiment

### [Configuration Example of Imaging Device]

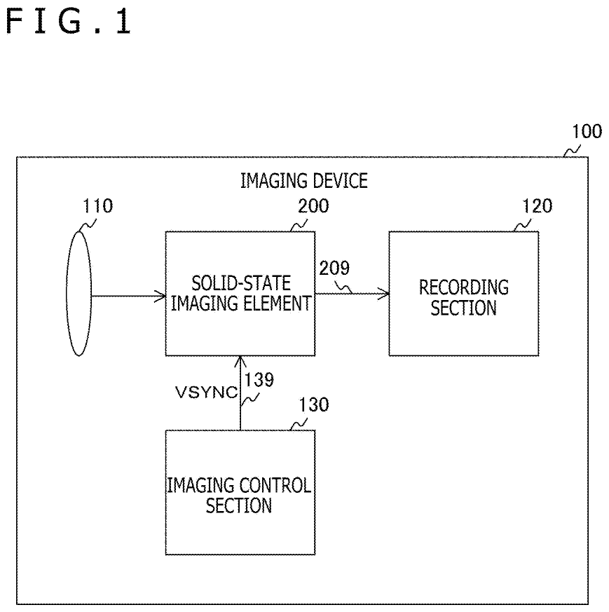

FIG. 1 is a block diagram depicting a configuration example of an imaging device 100 in the first embodiment of the present technology. The imaging device 100 is a device that captures image data, and includes an imaging lens 110, a solid-state imaging element 200, a recording section 120, and an imaging control section 130. It is supposed that the imaging device 100 is a digital camera or an electronic device (a smartphone, a personal computer, etc.) having an imaging function.

The solid-state imaging element 200 is configured to capture image data under the control of the imaging control section 130. The solid-state imaging element 200 supplies the image data to the recording section 120 via a signal line 209.

The imaging lens 110 is configured to condense light and guide the light to the solid-state imaging element 200. The imaging control section 130 is configured to control the solid-state imaging element 200 to capture image data. For example, the imaging control section 130 supplies imaging control signals including a vertical synchronizing signal VSYNC to the solid-state imaging element 200 via a signal line 139. The recording section 120 is configured to record the image data.

Here, the vertical synchronizing signal VSYNC is a signal representing the timing of imaging, and a periodic signal with a predetermined frequency (60 hertz, etc.) is used as the vertical synchronizing signal VSYNC.

Note that the imaging device 100 records the image data, but may transmit the image data to the outside of the imaging device 100. In this case, an external interface for transmitting image data is further provided. Alternatively, the imaging device 100 may further display image data. In this case, a display section is further provided.

### [Configuration Example of Solid-State Imaging Element]

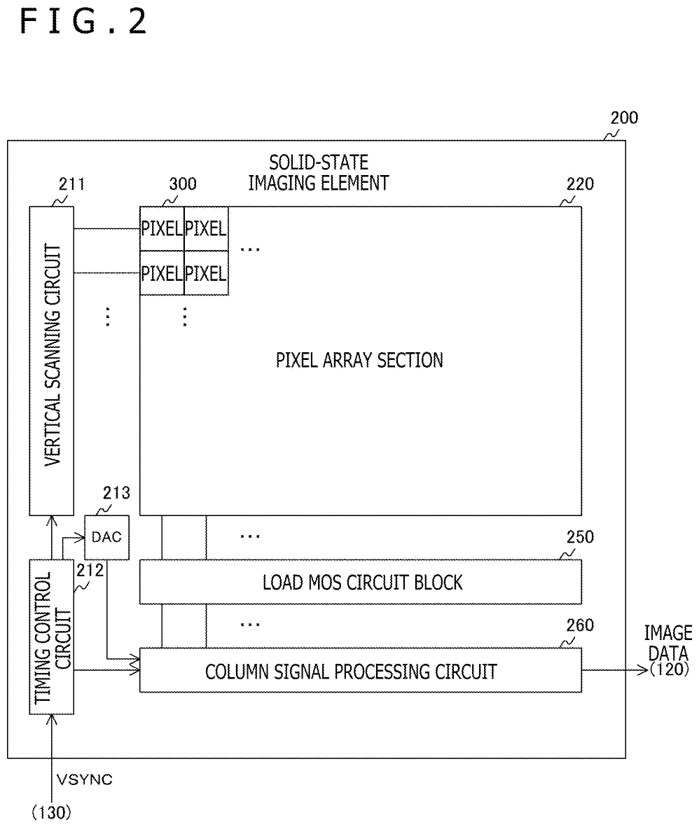

FIG. 2 is a block diagram depicting a configuration example of the solid-state imaging element 200 in the first embodiment of the present technology. The solid-state imaging element 200 includes a vertical scanning circuit 211, a pixel array section 220, a timing control circuit 212, a DAC (Digital to Analog Converter) 213, a load MOS circuit block 250, and a column signal processing circuit 260. The pixel array section 220 has a plurality of pixels 300 that are arrayed in a two-dimensional grid. In addition, for example, each circuit in the solid-state imaging element 200 is provided on a single semiconductor chip.

Hereinbelow, a set of pixels 300 arrayed in the horizontal direction is referred to as a “row,” and a set of pixels 300 arrayed in a direction perpendicular to rows is referred to as a “column.”

The timing control circuit 212 is configured to control respective operation timings of the vertical scanning circuit 211, the DAC 213, and the column signal processing circuit 260 in synchronization with the vertical synchronizing signal VSYNC from the imaging control section 130.

The DAC 213 is configured to generate a sawtooth-wave-patterned ramp signal by DA (Digital to Analog) conversion. The DAC 213 supplies the generated ramp signal to the column signal processing circuit 260.

The vertical scanning circuit 211 is configured to sequentially select and drive rows and cause analog pixel signals to be output. Each pixel 300 is configured to photoelectrically convert incident light and generate an analog pixel signal. The pixel 300 supplies the pixel signal to the column signal processing circuit 260 via the load MOS circuit block 250.

For each column, the load MOS circuit block 250 is provided with a MOS transistor that supplies a predetermined current.

The column signal processing circuit 260 is configured to execute signal processing such as an AD conversion process or CDS processing on pixel signals for each column. The column signal processing circuit 260 supplies, to the recording section 120, image data including signals that have been subjected to the processing. Note that the column signal processing circuit 260 is an example of a signal processing circuit described in claims.

### [Configuration Example of Pixel]

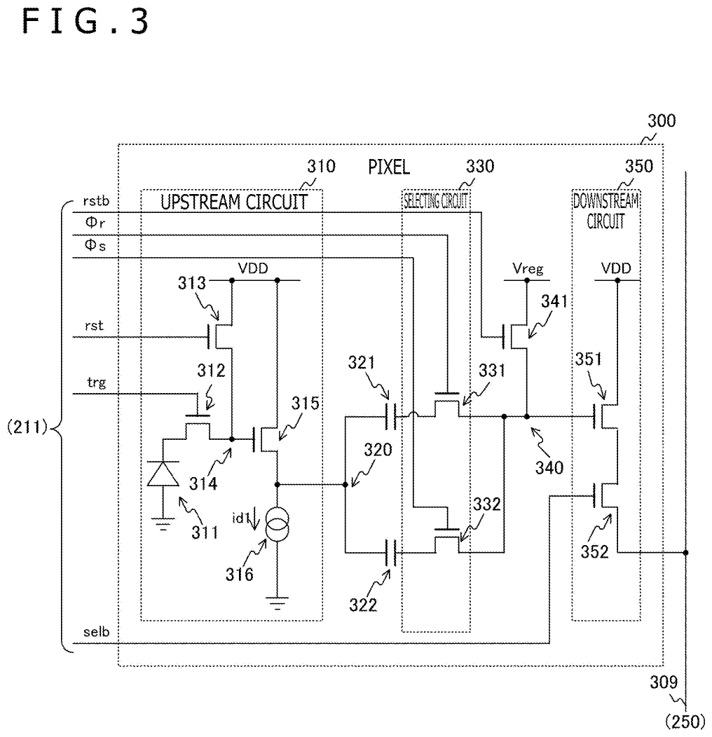

FIG. 3 is a circuit diagram depicting a configuration example of the pixel 300 in the first embodiment of the present technology. The pixel 300 includes an upstream circuit 310, capacitive elements 321 and 322, a selecting circuit 330, a downstream reset transistor 341, and a downstream circuit 350.

The upstream circuit 310 includes a photoelectric converting element 311, a transfer transistor 312, an FD (Floating Diffusion) reset transistor 313, an FD 314, an upstream amplification transistor 315, and a current source transistor 316.

The photoelectric converting element 311 is configured to generate a charge by photoelectric conversion. The transfer transistor 312 is configured to transfer the charge from the photoelectric converting element 311 to the FD 314 according to a transfer signal trg from the vertical scanning circuit 211.

The FD reset transistor 313 is configured to extract the charge from the FD 314 and initialize the FD 314 according to an FD reset signal rst from the vertical scanning circuit 211. The FD 314 is configured to accumulate a charge and generate a voltage according to the electric charge amount. The upstream amplification transistor 315 is configured to amplify the level of the voltage of the FD 314 and output the voltage to an upstream node 320. Note that the FD reset transistor 313 is an example of a first reset transistor described in claims. In addition, the upstream amplification transistor 315 is an example of a first amplification transistor described in claims.

In addition, sources of the FD reset transistor 313 and the upstream amplification transistor 315 are connected to a power supply voltage VDD. The current source transistor 316 is connected to a drain of the upstream amplification transistor 315. Under the control of the vertical scanning circuit 211, the current source transistor 316 supplies a current id1.

One end of each of the capacitive elements 321 and 322 shares a connection to the upstream node 320, and the other end of each of the capacitive elements 321 and 322 is connected to the selecting circuit 330. Note that the capacitive elements 321 and 322 are examples of first and second capacitive elements described in claims.

The selecting circuit 330 includes a selection transistor 331 and a selection transistor 332. The selection transistor 331 is configured to open and close a path between the capacitive element 321 and a downstream node 340 according to a selection signal Φr from the vertical scanning circuit 211. The selection transistor 332 is configured to open and close a path between a capacitive element 322 and the downstream node 340 according to a selection signal Φs from the vertical scanning circuit 211.

The downstream reset transistor 341 is configured to initialize the level of the downstream node 340 to a predetermined potential Vreg according to a downstream reset signal rstb from the vertical scanning circuit 211. The potential Vreg is set to a potential different from a power supply potential VDD (e.g., a potential lower than VDD).

The downstream circuit 350 includes a downstream amplification transistor 351 and a downstream selection transistor 352. The downstream amplification transistor 351 is configured to amplify the level of the downstream node 340. The downstream selection transistor 352 is configured to output, to a vertical signal line 309 and as a pixel signal, a signal at a level amplified by the downstream amplification transistor 351, according to a downstream selection signal selb from the vertical scanning circuit 211. Note that the downstream amplification transistor is an example of a second amplification transistor described in claims.

Note that, for example, nMOS (n-channel Metal Oxide Semiconductor) transistors are used as various types of transistors (the transfer transistor 312, etc.) in the pixel 300.

The vertical scanning circuit 211 supplies the high-level FD reset signal rst and transfer signal trg to all the pixels at the start of exposure. As a result, the photoelectric converting element 311 is initialized. Hereinbelow, this control is referred to as “PD resetting.”

Further, immediately before the end of exposure, the vertical scanning circuit 211 supplies the high-level FD reset signal rst over a pulse period while switching the downstream reset signal rstb and the selection signal or to the high levels for all the pixels. As a result, the FD 314 is initialized, and a level according to the level of the FD 314 at that time is held at the capacitive element 321. This control is referred to as “FD resetting” hereinbelow.

The level of the FD 314 at the time of FD resetting and a level (the hold level of the capacitive element 321 and the level of the vertical signal line 309) corresponding to the level of the FD 314 at the time of FD resetting are collectively referred to as a “P phase” or a “reset level” hereinbelow.

At the end of exposure, the vertical scanning circuit 211 supplies the high-level transfer signal trg over a pulse period while switching the downstream reset signal rstb and the selection signal Φs to the high levels for all the pixels. As a result, a signal charge according to an exposure amount is transferred to the FD 314, and a level according to the level of the FD 314 at that time is held at the capacitive element 322.

The level of the FD 314 at the time of signal charge transfer and a level (the hold level of the capacitive element 322 and the level of the vertical signal line 309) corresponding to the level of the FD 314 at the time of signal charge transfer are collectively referred to as a “D phase” or a “signal level” hereinbelow.

The exposure control in which exposure is started and ended simultaneously for all the pixels as described above is called a global shutter scheme. With this exposure control, the upstream circuit 310 of each of all the pixels sequentially generates a reset level and a signal level. The reset level is held at the capacitive element 321, and the signal level is held at the capacitive element 322.

After the end of exposure, the vertical scanning circuit 211 sequentially selects rows, and causes reset levels and signal levels of a selected row to be sequentially output. When the reset levels are to be caused to be output, the vertical scanning circuit 211 supplies the high-level selection signal Φr over a predetermined period while switching the FD reset signal rst and the downstream selection signal selb for the selected row to the high levels. As a result, the capacitive elements 321 are connected to the downstream nodes 340, and the reset levels are read out.

After the reset-level readout, the vertical scanning circuit 211 supplies the high-level downstream reset signal rstb over a pulse period while keeping the FD reset signal rst and the downstream selection signal selb for the selected row at the high levels. As a result, the levels of the downstream nodes 340 are initialized. At this time, both the selection transistors 331 and the selection transistors 332 are in the opened state, and the capacitive elements 321 and 322 are disconnected from the downstream nodes 340.

After the initialization of the downstream nodes 340, the vertical scanning circuit 211 supplies the high-level selection signal Φs over a predetermined period while keeping the FD reset signal rst and the downstream selection signal selb for the selected row at the high levels. As a result, the capacitive elements 322 are connected to the downstream nodes 340, and the signal levels are read out.

With the readout control described above, the selecting circuits 330 in the selected row sequentially perform control of connecting the capacitive elements 321 to the downstream nodes 340, control of disconnecting the capacitive elements 321 and 322 from the downstream nodes 340, and control of connecting the capacitive elements 322 to the downstream nodes 340. In addition, when the capacitive elements 321 and 322 are disconnected from the downstream nodes 340, the downstream reset transistors 341 in the selected row initialize the levels of the downstream nodes 340. In addition, the downstream circuits 350 in the selected row sequentially read out the reset levels and the signal levels from the capacitive elements 321 and 322 via the downstream nodes 340, and output the reset levels and the signal levels to the vertical signal lines 309.

### [Configuration Example of Column Signal Processing Circuit]

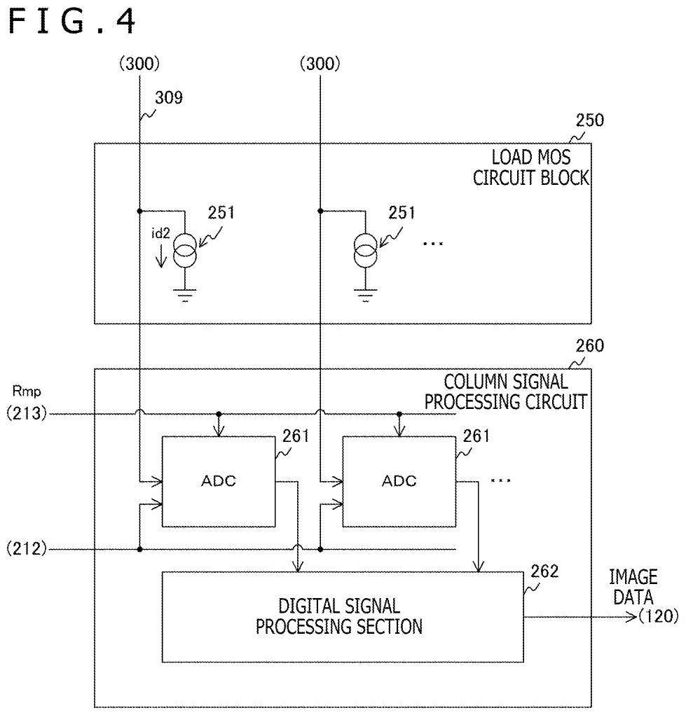

FIG. 4 is a block diagram depicting configuration examples of the load MOS circuit block 250 and the column signal processing circuit 260 in the first embodiment of the present technology.

In the load MOS circuit block 250, a vertical signal line 309 is placed for each column. Supposing that the number of columns is I (I is an integer), I vertical signal lines 309 are placed. In addition, each of the vertical signal lines 309 is connected with a load MOS transistor 251 that supplies a predetermined current id2. In the column signal processing circuit 260, a plurality of ADCs 261 and a digital signal processing section 262 are arranged. An ADC 261 is arranged for each column. Supposing that the number of columns is I, I ADCs 261 are arranged.

Each ADC 261 is configured to convert an analog pixel signal from the corresponding column to a digital signal by using a ramp signal Rmp from the DAC 213. The ADC 261 supplies the digital signal to the digital signal processing section 262. For example, as the ADC 261, a single-slope-type ADC including a comparator and a counter is arranged.

The digital signal processing section 262 is configured to perform predetermined signal processing such as CDS processing on each of digital signals of each column. The digital signal processing section 262 supplies, to the recording section 120, image data including digital signals that have been subjected to the processing.

### [Operation Example of Solid-State Imaging Element]

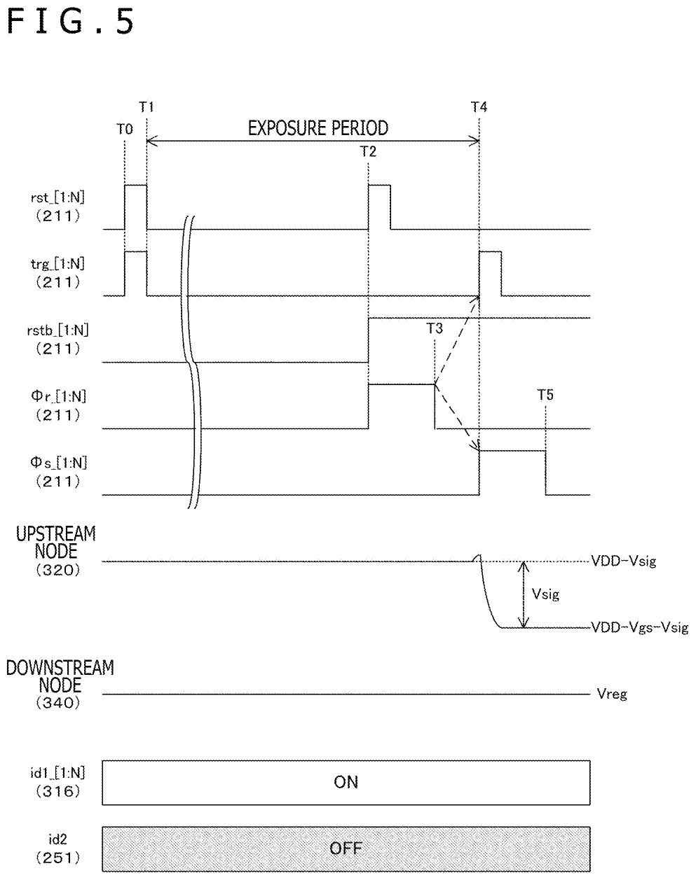

FIG. 5 is a timing chart depicting an example of a global shutter operation in the first embodiment of the present technology. From timing T0 immediately before the start of exposure to timing T1 after a lapse of a pulse period, the vertical scanning circuit 211 supplies the high-level FD reset signal rst and transfer signal trg to all the rows (i.e., all the pixels). As a result, all the pixels are PD-reset, and exposure is started simultaneously in all the rows.

Here, rst [n] and trg_[n] in the figure represent signals to pixels in the n-th row in N rows. N is an integer representing the number of all the rows, and n is an integer from 1 to N.

Then, at timing T2 which is immediately before the end of the exposure period, the vertical scanning circuit 211 supplies the high-level FD reset signal rst over a pulse period while switching the downstream reset signal rstb and the selection signal Φr for all the pixels to the high levels. As a result, all the pixels are FD-reset, and the reset levels are sample-held. Here, rstb_[n] and Φr_[n] in the figure represent signals to pixels in the n-th row.

At timing T3 after timing T2, the vertical scanning circuit 211 switches the selection signal Φr back to the low level.

At timing T4 at the end of exposure, the vertical scanning circuit 211 supplies the high-level transfer signal trg over a pulse period while switching the downstream reset signal rstb and the selection signal Φs to the high levels for all the pixels. As a result, the signal levels are sample-held. In addition, the levels of the upstream nodes 320 lower from reset levels (VDD-Vsig) to signal levels (VDD-Vgs-Vsig). Here, VDD is a power supply voltage, and Vsig is a net signal level obtained with CDS processing. Vgs is the gate-source voltage of the upstream amplification transistors 315. In addition, Φs_[n] in the figure represents a signal to pixels in the n-th row.

At timing T5 after timing T4, the vertical scanning circuit 211 switches the selection signal Φs back to the low level.

In addition, the vertical scanning circuit 211 controls the current source transistors 316 of all the rows (all the pixels) to supply the current id1. Here, id1_[n] in the figure represents currents of pixels in the n-th row. Since an IR drop increases when a current id becomes a large current, the current id1 needs to be in the order of several nano-amperes (nA) to several dozen nano-amperes (nA). On the other hand, the load MOS transistors 251 in all the columns are in the OFF state, and the current id2 is not supplied to the vertical signal lines 309.

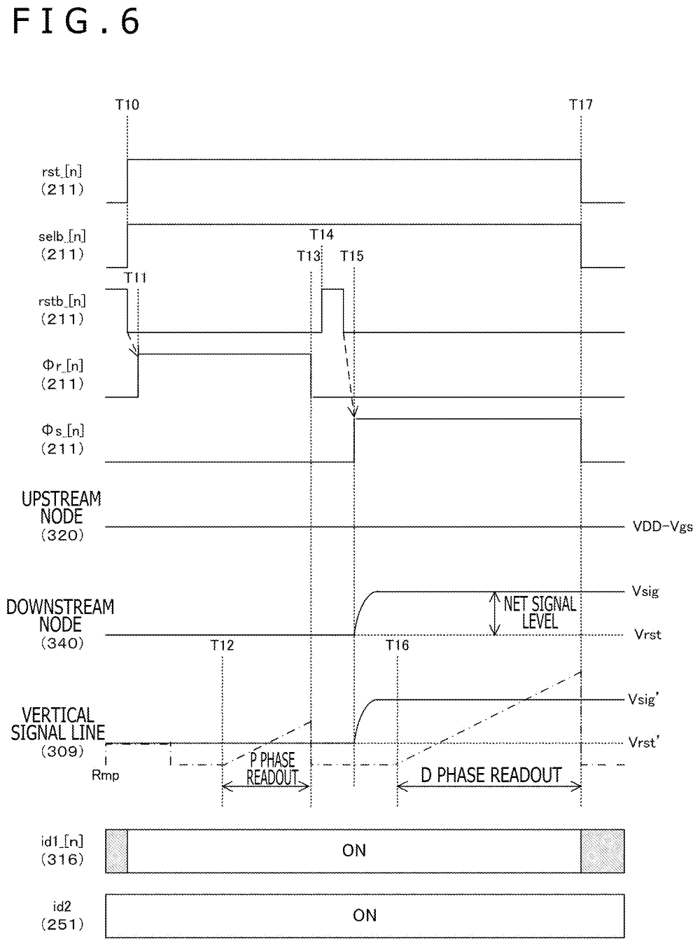

FIG. 6 is a timing chart depicting an example of a readout operation in the first embodiment of the present technology. In the readout period of the n-th row from timing T10 to timing T17, the vertical scanning circuit 211 switches the FD reset signals rst and the downstream selection signals selb for the n-th row to the high levels. In addition, in the readout period, the downstream reset signal rstb for all the rows is controlled to be at the low level. Here, selb_[n] in the figure represents a signal to pixels in the n-th row.

Over the period from timing T11 immediately after timing T10 to timing T13, the vertical scanning circuit 211 supplies the high-level selection signal Φr to the n-th row. The potential of the downstream node 340 becomes a reset level Vrst.

The DAC 213 gradually raises the ramp signal Rmp over the period from timing T12 after timing T11 to timing T13. The ADC 261 compares the ramp signal Rmp and a level Vrst′ of the vertical signal line 309, and performs counting with a count until the comparison result is inverted. As a result, the P-phase level (reset level) is read out.

The vertical scanning circuit 211 supplies the high-level downstream reset signal rstb to the n-th row over the pulse period from timing T14 immediately after timing T13. As a result, when there is a parasitic capacitance in the downstream node 340, it is possible to erase the history of a previous signal held at the parasitic capacitance.

The vertical scanning circuit 211 supplies the high-level selection signal Φs to the n-th row over the period from timing T15 immediately after the initialization of the downstream node 340 to timing T17. The potential of the downstream node 340 becomes a signal level Vsig. Although the signal level is lower than the reset level at the time of exposure, the signal level is higher than the reset level at the time of readout since the downstream node 340 is used as a reference node. The difference between the reset level Vrst and the signal level Vsig corresponds to a net signal level from which reset noise or offset noise of FDs has been removed.

The DAC 213 gradually raises the ramp signal Rmp over the period from timing T16 after timing T15 to timing T17. The ADC 261 compares the ramp signal Rmp and the level Vrst′ of the vertical signal line 309, and performs counting with a count until the comparison result is inverted. As a result, the D-phase level (signal level) is read out.

In addition, the vertical scanning circuit 211 controls the current source transistors 316 in the n-th row which are the subject of readout to supply the current id1 over the period from timing T10 to timing T17. In addition, the timing control circuit 212 controls the load MOS transistors 251 in all the columns to supply the current id2 in a readout period of all the rows.

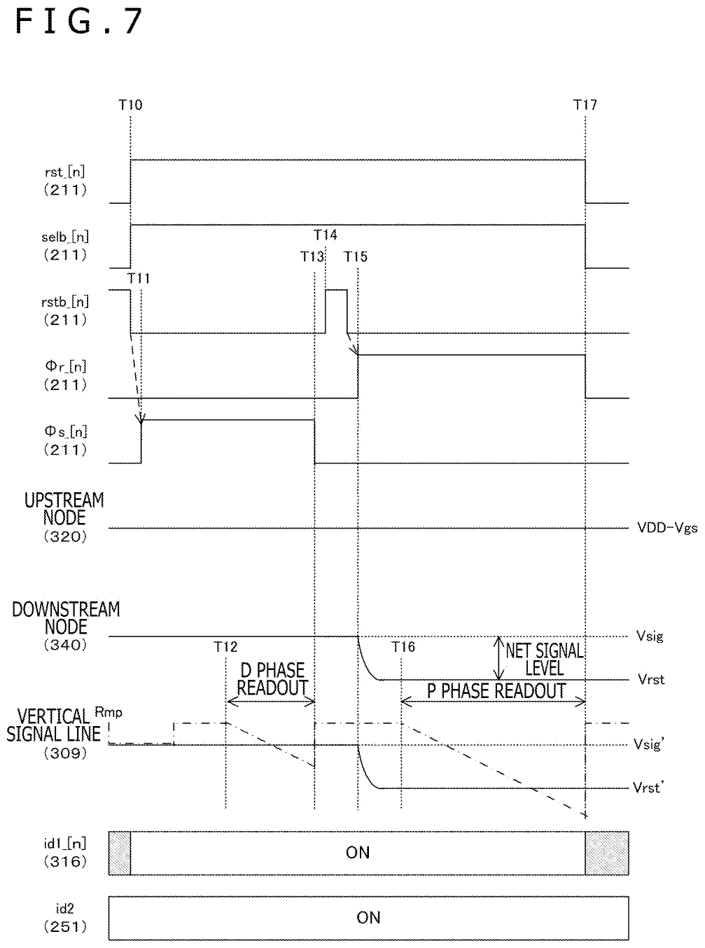

Note that, whereas the solid-state imaging element 200 reads out signal levels after reset levels, the order of readout is not limited to this order. As illustrated in FIG. 7, the solid-state imaging element 200 can also read out reset levels after signal levels. In this case, as illustrated in the figure, the vertical scanning circuit 211 supplies the high-level selection signal Φr after the high-level selection signal Φs. In addition, in this case, the inclination of the slope of the ramp signal needs to be made opposite.

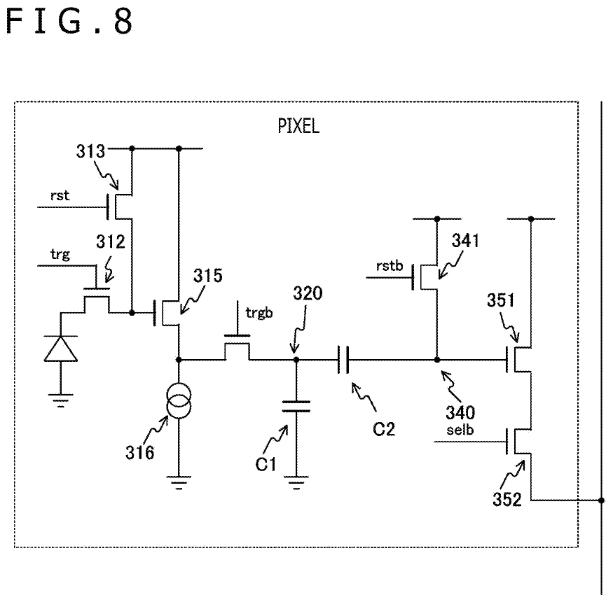

FIG. 8 is a circuit diagram depicting a configuration example of a pixel in a comparative example. In the comparative example, the selecting circuit 330 is not provided, but a transfer transistor is inserted between the upstream node 320 and the upstream circuit. In addition, instead of the capacitive elements 321 and 322, capacitances C1 and C2 are inserted. The capacitance C1 is inserted between the upstream node 320 and a ground terminal, and the capacitance C2 is inserted between the upstream node 320 and the downstream node 340.

For example, pixel exposure control and readout control in the comparative example are described in FIG. 5.5.2 of NPL 1. In the comparative example, supposing that the capacitance value of each of the capacitances C1 and C2 is C, a level Vn of kTC noise at the times of exposure and readout is represented by the following formula.

$${V}_{n} = {( 3 * kT / C )}^{1 / 2} \qquad Formula 1$$

In the formula above, k is the Boltzmann constant which is expressed in the unit of joule per kelvin (J/K), for example. T is an absolute temperature which is expressed in the unit of kelvin (K), for example. In addition, Vn is expressed in the unit of volt (V), for example, and C is expressed in the unit of farad (F), for example.

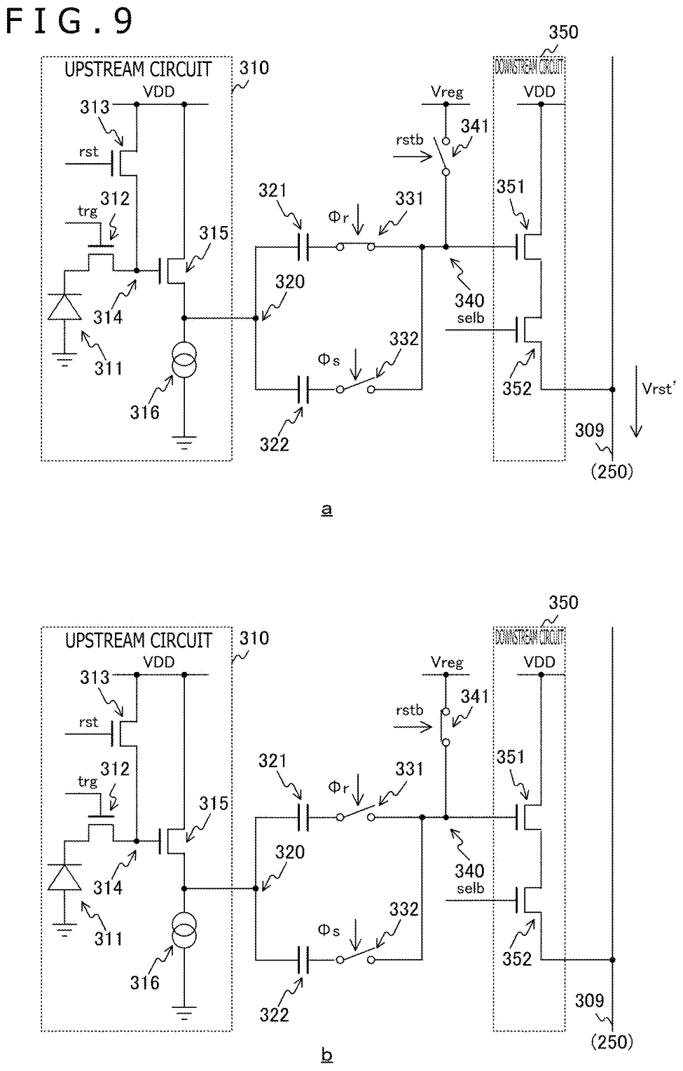

FIG. 9 is a figure depicting examples of a state of the pixel at the time of reset-level readout and a state of the pixel at the time of initialization of the downstream node in the first embodiment of the present technology. “a” in the figure depicts a state of the pixel 300 at the time of reset-level readout, and “b” in the figure depicts a state of the pixel 300 at the time of initialization of the downstream node 340. In addition, in the figure, the selection transistor 331, the selection transistor 332, and the downstream reset transistor 341 are represented by graphic symbols of switches for convenience of explanation.

As illustrated in “a” in the figure, the vertical scanning circuit 211 switches the selection transistor 331 to the closed state, and switches the selection transistor 332 and the downstream reset transistor 341 to the opened state. As a result, the reset level is read out via the downstream circuit 350.

After the reset-level readout, as illustrated in “b” in the figure, the vertical scanning circuit 211 switches the selection transistors 331 and the selection transistor 332 to the opened state, and switches the downstream reset transistor 341 to the closed state. As a result, the capacitive elements 321 and 322 are disconnected from the downstream node 340, and the level of the downstream node 340 is initialized.

It is supposed that the capacitance value of a parasitic capacitance Cp of the downstream node 340 in a state where the downstream node 340 is disconnected from the capacitive elements 321 and 322 as described above is very small as compared with the capacitive elements 321 and 322. For example, supposing that the parasitic capacitance Cp is several femtofarads (fF), the capacitive elements 321 and 322 are in the order of several dozen femtofarads.

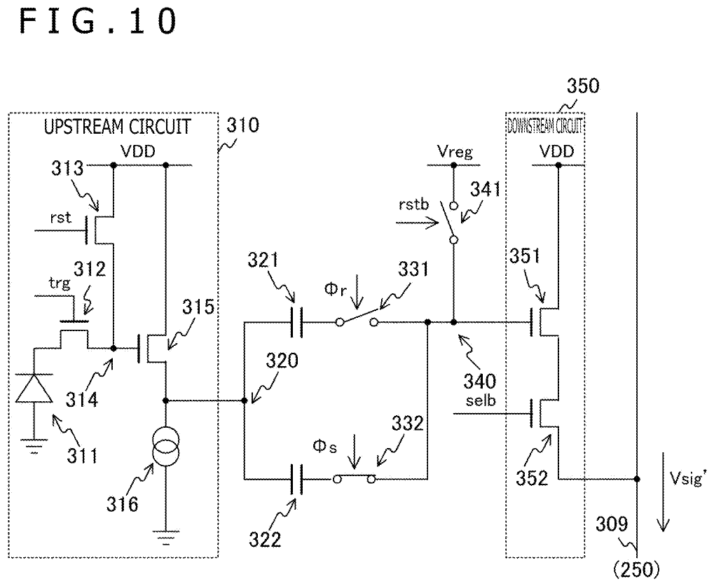

FIG. 10 is a figure depicting an example of a state of the pixel 300 at the time of signal-level readout in the first embodiment of the present technology.

After the initialization of the downstream node 340, the vertical scanning circuit 211 switches the selection transistor 332 to the closed state, and switches the selection transistor 331 and the downstream reset transistor 341 to the opened state. As a result, the signal level is read out via the downstream circuit 350.

Here, kTC noise at the time of exposure of the pixel 300 is examined. At the time of exposure, kTC noise occurs in each of sampling of the reset level and sampling of the signal level immediately before the end of exposure. Supposing that the capacitance value of each of the capacitive elements 321 and 322 is C, the level Vn of the kTC noise at the time of exposure is represented by the following formula.

$${V}_{n} = {( 2 * kT / C )}^{1 / 2} \qquad Formula 2$$

In addition, since the downstream reset transistor 341 is being driven at the time of readout as illustrated in FIG. 9 and FIG. 10, kTC noise occurs at that time. However, the capacitive elements 321 and 322 are disconnected at the time of driving of the downstream reset transistor 341, and the parasitic capacitance Cp at that time is small. Because of this, kTC noise at the time of readout is negligible as compared with kTC noise at the time of exposure. Accordingly, kTC noise at the times of exposure and readout is represented by Formula 2.

According to Formula 1 and Formula 2, kTC noise of the pixel 300 in which the capacitances are disconnected at the time of readout is smaller than in the comparative example in which the capacitances cannot be disconnected at the time of readout. As a result, the image quality of image data can be improved.

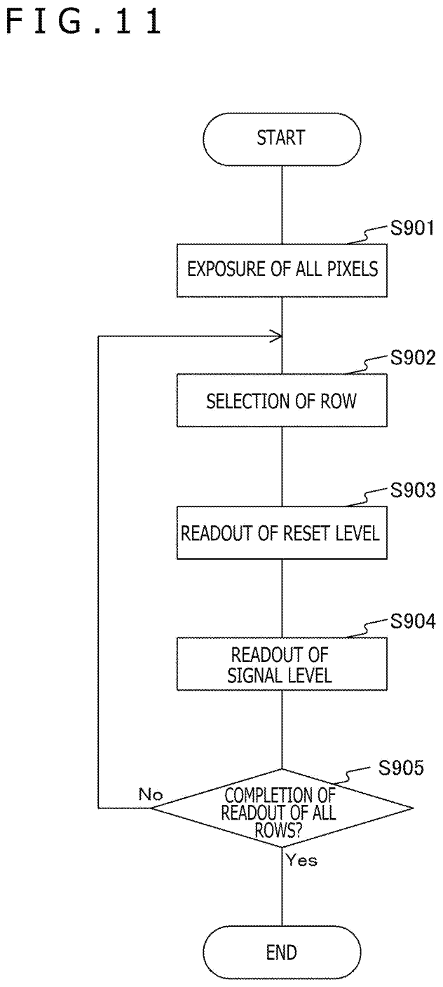

FIG. 11 is a flowchart depicting an example of an operation of the solid-state imaging element 200 in the first embodiment of the present technology. For example, this operation is started when a predetermined application for capturing image data is executed.

The vertical scanning circuit 211 performs exposure of all the pixels (step S901). Then, the vertical scanning circuit 211 selects a row to read out (step S902). The column signal processing circuit 260 performs reset-level readout of the selected row (step S903), and next performs signal-level readout (step S904).

The solid-state imaging element 200 determines whether or not readout of all the rows has been completed (step S905). In a case where readout of all the rows has not been completed (step S905: No), the solid-state imaging element 200 repeats step S902 and the subsequent steps. On the other hand, in a case where readout of all the rows has been completed (step S905: Yes), the solid-state imaging element 200 executes CDS processing or the like, and ends the operation for imaging. In a case where a plurality of pieces of image data are to be captured consecutively, steps S901 to S905 are executed repeatedly in synchronization with vertical synchronizing signals.

In such a manner, in the first embodiment of the present technology, the downstream reset transistor 341 initializes the downstream node 340 when the selecting circuit 330 disconnects the capacitive elements 321 and 322 from the downstream node 340. Since the capacitive elements 321 and 322 are disconnected, the level of reset noise due to driving of the capacitive elements 321 and 322 becomes a level according to a parasitic capacitance smaller than their capacitances. Due to this noise reduction, the image quality of image data can be improved.

### First Modification Example

Whereas signals are read out while the upstream circuit 310 is kept connected to the upstream node 320 in the first embodiment described above, it is impossible with this configuration to block noise from the upstream node 320 at the time of readout. The pixels 300 in the first modification example of the first embodiment are different from those in the first embodiment in that a transistor is inserted between the upstream circuit 310 and the upstream node 320.

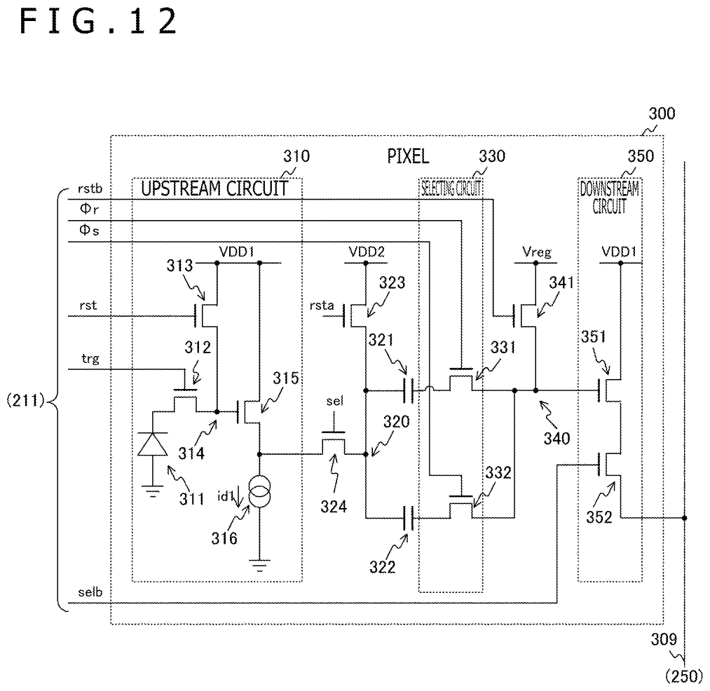

FIG. 12 is a circuit diagram depicting a configuration example of the pixel 300 in the first modification example of the first embodiment of the present technology. The pixels 300 in the first modification example of the first embodiment are different from those in the first embodiment in that each pixel 300 further includes an upstream reset transistor 323 and an upstream selection transistor 324. In addition, it is supposed that the power supply voltage of the upstream circuit 310 and the downstream circuit 350 in the first modification example of the first embodiment is VDD1.

The upstream reset transistor 323 is configured to initialize the level of the upstream node 320 by using a power supply voltage VDD2. It is desirable that this power supply voltage VDD2 be set to a value that satisfies the following formula.

$$V DD 2 = V DD 1 - V gs \qquad Formula 3$$

In the formula above, Vgs is the gate-source voltage of the upstream amplification transistors 315.

By setting the power supply voltage VDD2 to a value that satisfies Formula 3, potential variations between the upstream node 320 and the downstream node 340 in a case of a dark environment can be reduced. As a result, the photo response non-uniformity (PRNU) can be ameliorated.

The upstream selection transistor 324 is configured to open and close a path between the upstream circuit 310 and the upstream node 320 according to an upstream selection signal sel from the vertical scanning circuit 211.

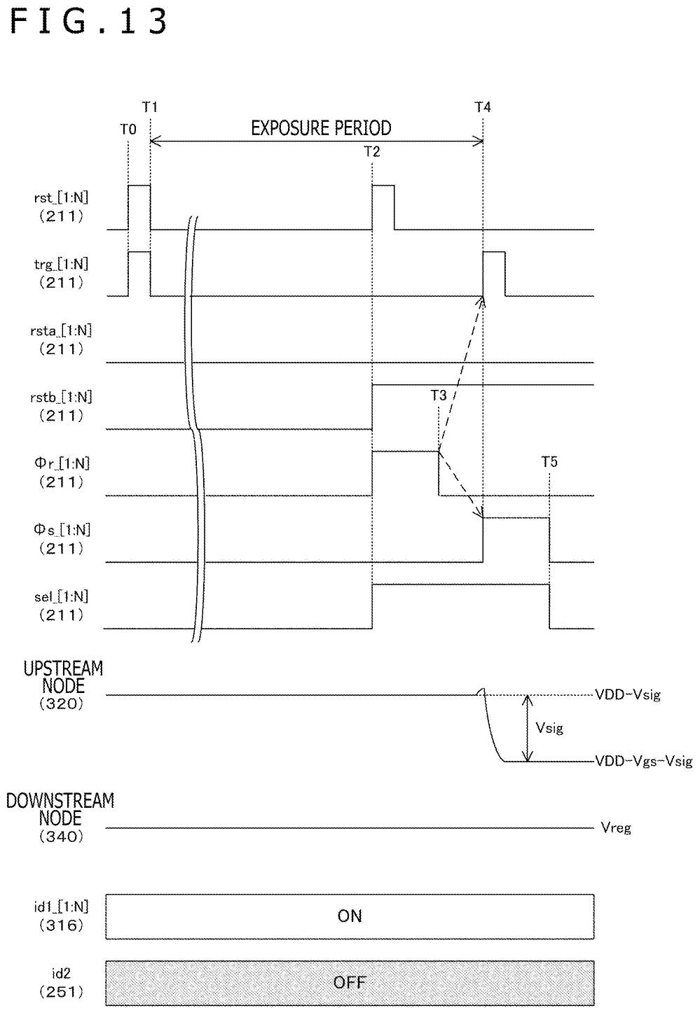

FIG. 13 is a timing chart depicting an example of the global shutter operation in the first modification example of the first embodiment of the present technology. The timing chart in the first modification example of the first embodiment is different from that in the first embodiment in that the vertical scanning circuit 211 further supplies an upstream reset signal rsta and the upstream selection signal sel. In the figure, rsta_[n] and sel_[n] represent signals to pixels in the n-th row.

The vertical scanning circuit 211 supplies the high-level upstream selection signal sel to all the pixels from timing T2 immediately before the end of exposure to timing T5. The upstream reset signal rsta is controlled to be at the low level.

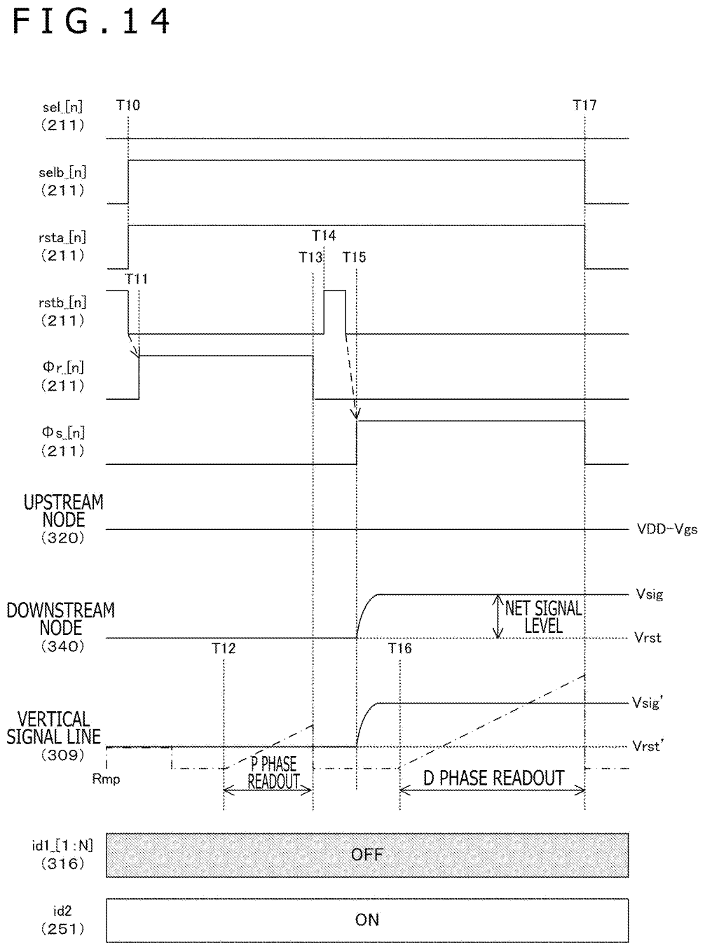

FIG. 14 is a timing chart depicting an example of the readout operation in the first modification example of the first embodiment of the present technology. At the time of readout of each row, the upstream selection signal sel is controlled to be at the low level. With this control, the upstream selection transistor 324 transitions to the opened state, and the upstream node 320 is disconnected from the upstream circuit 310. As a result, at the time of readout, noise from the upstream node 320 can be blocked.

In addition, in the readout period of the n-th row from timing T10 to timing T17, the vertical scanning circuit 211 supplies the high-level upstream reset signal rsta to the n-th row.

In addition, at the time of readout, the vertical scanning circuit 211 controls the current source transistor 316 of every pixel to stop the supply of the current id1. The current id2 is supplied as in the first embodiment. In such a manner, as compared with the first embodiment, control of the current id1 is simplified.

Since the upstream selection transistor 324 transitions to the opened state and the upstream circuit 310 is disconnected from the upstream node 320 at the time of readout according to the first modification example of the first embodiment of the present technology as described above, noise from the upstream circuit 310 can be blocked.

### Second Modification Example

Whereas circuits in the solid-state imaging element 200 are provided on a single semiconductor chip in the first embodiment described above, there is a risk with this configuration that elements cannot be contained in the semiconductor chip when pixels 300 are miniaturized. The solid-state imaging element 200 in the second modification example of the first embodiment is different from that in the first embodiment in that circuits in the solid-state imaging element 200 are dispersedly arranged on two semiconductor chips.

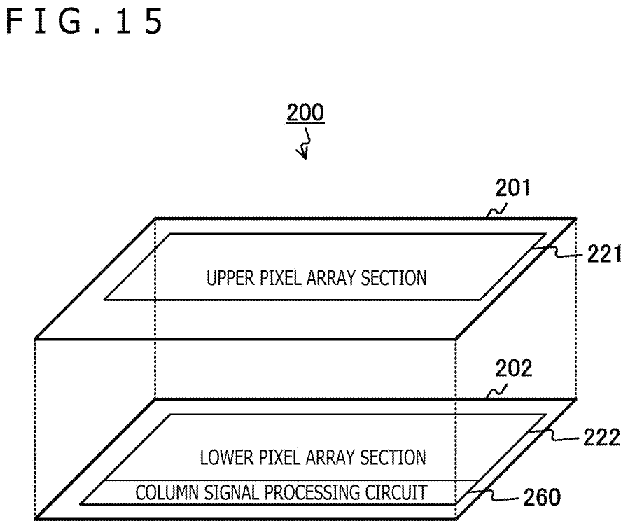

FIG. 15 is a figure depicting an example of a stacked structure of the solid-state imaging element 200 in the second modification example of the first embodiment of the present technology. The solid-state imaging element 200 in the second modification example of the first embodiment includes a lower pixel chip 202 and an upper pixel chip 201 stacked on the lower pixel chip 202. For example, these chips are electrically connected to each other by Cu—Cu junctions. Note that they can also be connected to each other by vias or bumps, other than Cu—Cu junctions.

An upper pixel array section 221 is arranged on the upper pixel chip 201. A lower pixel array section 222 and the column signal processing circuit 260 are arranged on the lower pixel chip 202. A part of each pixel in the pixel array section 220 is arranged on the upper pixel array section 221, and the rest is arranged on the lower pixel array section 222.

In addition, the vertical scanning circuit 211, the timing control circuit 212, the DAC 213, and the load MOS circuit block 250 are also arranged on the lower pixel chip 202. These circuits are omitted in the figure.

In addition, for example, the upper pixel chip 201 is manufactured by a process dedicated for pixels, and, for example, the lower pixel chip 202 is manufactured by a CMOS (Complementary MOS) process. Note that the upper pixel chip 201 is an example of a first chip described in claims, and the lower pixel chip 202 is an example of a second chip described in claims.

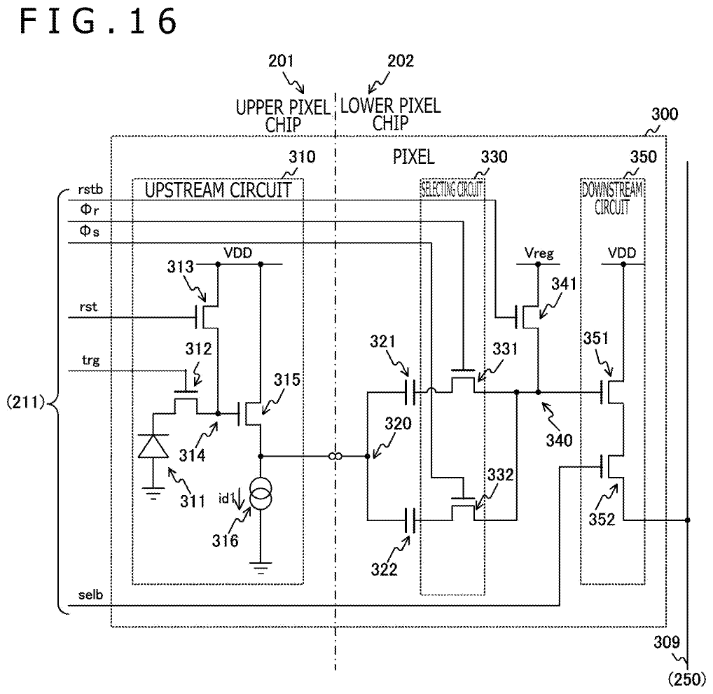

FIG. 16 is a circuit diagram depicting a configuration example of the pixel 300 in the second modification example of the first embodiment of the present technology. In the pixel 300, the upstream circuit 310 is arranged on the upper pixel chip 201, and other circuits or elements (the capacitive elements 321 and 322, etc.) are arranged on the lower pixel chip 202. Note that, in addition, the current source transistor 316 can also be arranged on the lower pixel chip 202. By dispersedly arranging elements in the pixel 300 on the stacked upper pixel chip 201 and lower pixel chip 202 as illustrated in the figure, the pixel area size can be reduced, and miniaturization of pixels becomes easier.

Since circuits and elements in the pixels 300 are dispersedly arranged on the two semiconductor chips according to the second modification example of the first embodiment of the present technology as described above, miniaturization of pixels becomes easier.

### Third Modification Example

In the second modification example of the first embodiment described above, a part of each pixel 300 and peripheral circuits (the column signal processing circuit 260, etc.) are provided on the lower pixel chip 202 on the lower side. However, there is a risk with this configuration that the arrangement area size of circuits and elements on the side of the lower pixel chip 202 becomes greater than the upper pixel chip 201 by an amount corresponding to the peripheral circuits and a wasted space where there are no circuits or elements is generated on the upper pixel chip 201. The solid-state imaging element 200 in the third modification example of the first embodiment is different from that in the second modification example of the first embodiment in that circuits in the solid-state imaging element 200 are dispersedly arranged on three semiconductor chips.

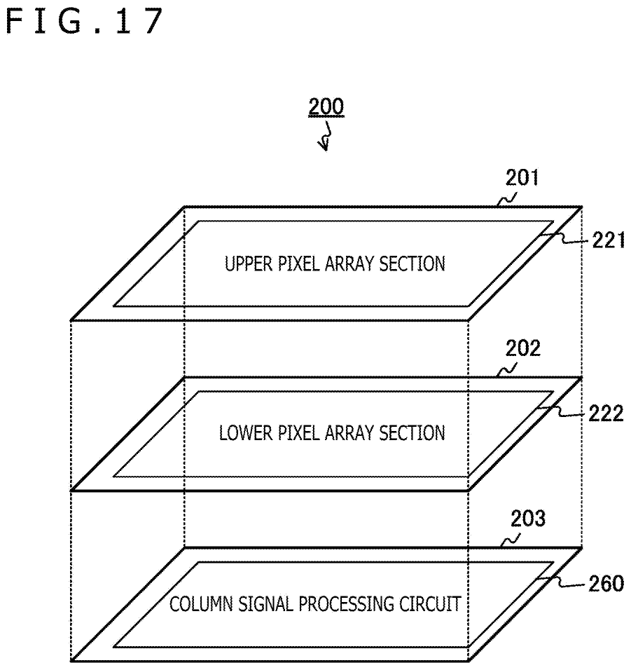

FIG. 17 is a figure depicting an example of the stacked structure of the solid-state imaging element 200 in the third modification example of the first embodiment of the present technology. The solid-state imaging element 200 in the third modification example of the first embodiment includes the upper pixel chip 201, the lower pixel chip 202, and a circuit chip 203. For example, these chips are stacked one on another, and are electrically connected to one another by Cu—Cu junctions. Note that they can also be connected to one another by vias or bumps, other than Cu—Cu junctions.

The upper pixel array section 221 is arranged on the upper pixel chip 201. The lower pixel array section 222 is arranged on the lower pixel chip 202. A part of each pixel in the pixel array section 220 is arranged on the upper pixel array section 221, and the rest is arranged on the lower pixel array section 222.

In addition, the column signal processing circuit 260, the vertical scanning circuit 211, the timing control circuit 212, the DAC 213, and the load MOS circuit block 250 are arranged on the circuit chip 203. Circuits other than the column signal processing circuit 260 are omitted in the figure.

Note that the upper pixel chip 201 is an example of the first chip described in claims, and the lower pixel chip 202 is an example of the second chip described in claims. The circuit chip 203 is an example of a third chip described in claims.

By adopting a three-layer configuration as illustrated in the figure, it is possible to reduce a wasted space and further miniaturize pixels as compared with the two-layer configuration. In addition, the lower pixel chip 202 on the second layer can be manufactured by a process dedicated for capacitances or switches.

Since circuits in the solid-state imaging element 200 are dispersedly arranged on the three semiconductor chips in the third modification example of the first embodiment of the present technology as described above, pixels can be miniaturized further as compared with the case where the circuits are dispersedly arranged on the two semiconductor chips.

### 2. Second Embodiment

Whereas reset levels are sample-held in exposure periods in the first embodiment described above, it is impossible with this configuration to make exposure periods shorter than reset-level sample-hold periods. The solid-state imaging element 200 in the second embodiment is different from that in the first embodiment in that exposure periods are made shorter by adding transistors to discharge charges from the photoelectric converting elements.

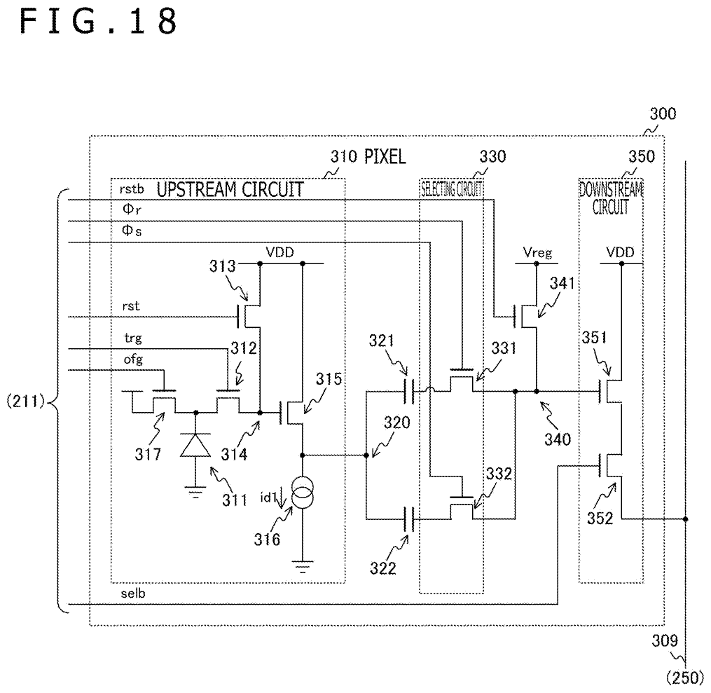

FIG. 18 is a circuit diagram depicting a configuration example of the pixel 300 in the second embodiment of the present technology. The pixels 300 in the second embodiment are different from those in the first embodiment in that each pixel 300 further includes a discharge transistor 317 in the upstream circuit 310. The discharge transistor 317 is configured to function as an overflow drain that discharges a charge from the photoelectric converting element 311 according to a discharge signal ofg from the vertical scanning circuit 211. For example, an nMOS transistor is used as the discharge transistor 317.

With the configuration not provided with the discharge transistor 317 as in the first embodiment, in all the pixels, blooming may occur when charges are transferred from the photoelectric converting elements 311 to the FDs 314. Then, at the time of FD resetting, the potentials of the FDs 314 and the upstream nodes 320 fall. Following these falls of the potentials, charge and discharge currents of the capacitive elements 321 and 322 keep being generated, and IR drops of a power supply and a ground change from the steady state in which no blooming occurs, undesirably.

On the other hand, at the time of sample-holding of the signal levels of all the pixels, charges in the photoelectric converting elements 311 become empty after signal charge transfer; accordingly blooming no longer occurs, and IR drops of the power supply and the ground become the steady state in which no blooming occurs. Due to the difference between the IR drops at the time of sample-holding of the reset levels and the signal levels, streaking noise is generated.

To cope with this, charges of the photoelectric converting elements 311 are discharged toward the side of the overflow drains in the second embodiment in which the discharge transistors 317 are provided. Because of this, the IR drops at the time of sample-holding of the reset levels and the signal levels become approximately the same, and streaking noise can be suppressed.

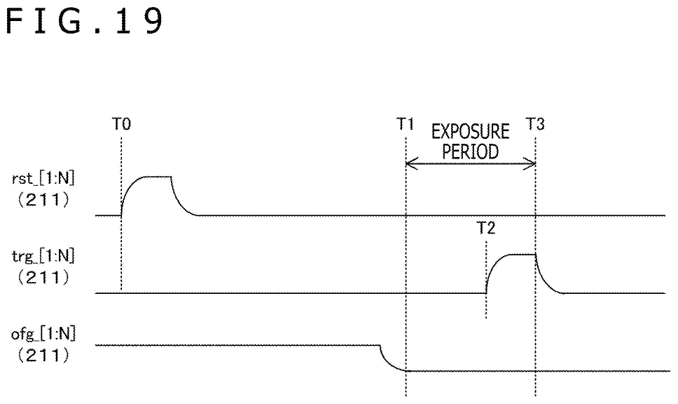

FIG. 19 is a timing chart depicting an example of the global shutter operation in the second embodiment of the present technology. At timing T0 before the timing at the start of exposure, the vertical scanning circuit 211 supplies the high-level FD reset signal rst to all the pixels over a pulse period while switching the discharge signal ofg for all the pixels to the high level. As a result, PD resetting and FD resetting are performed for all the pixels. In addition, the reset levels are sample-held. Here, ofg_[n] in the figure represents a signal to pixels in the n-th row in the N rows.

Then, at timing T1 at the start of exposure, the vertical scanning circuit 211 switches the discharge signal ofg for all the pixels back to the low level. Then, over the period from timing T2 immediately before the end of exposure to T3 at the end of exposure, the vertical scanning circuit 211 supplies the high-level transfer signal trg to all the pixels. As a result, the signal levels are sample-held.

In the configuration not provided with the discharge transistor 317 as in the first embodiment, both the transfer transistor 312 and the FD reset transistor 313 have to be switched to the ON state at the start of exposure (i.e., at the time of PD resetting). In this control, the FD 314 also has to be reset simultaneously at the time of PD resetting. Because of this, it is necessary to perform FD resetting in an exposure period again and sample-hold the reset level, and exposure periods cannot be made shorter than reset-level sample-hold periods. At the time when the reset levels of all the pixels are sample-held, a certain amount of waiting time is necessary until voltages and currents become stationary, and, for example, a sample-hold period of several microseconds (μs) to several dozen microseconds (μs) is necessary.

In contrast to this, in the second embodiment in which the discharge transistors 317 are provided, PD resetting and FD resetting can be performed separately. Owing to this, as illustrated in the figure, FD resetting can be performed and the reset levels can be sample-held before PD resetting is terminated (the start of exposure). As a result, exposure periods can be made shorter than reset-level sample-hold periods.

Note that the first to third modification examples of the first embodiment can also be applied to the second embodiment.

Since the discharge transistors 317 that discharge charges from the photoelectric converting elements 311 are provided according to the second embodiment of the present technology as described above, FD resetting can be performed and the reset levels can be sample-held before the start of exposure. As a result, exposure periods can be made shorter than reset-level sample-hold periods.

### 3. Third Embodiment

Whereas the FD 314 is initialized by use of the power supply voltage VDD in the first embodiment described above, there is a risk with this configuration that the photo response non-uniformity (PRNU) worsens due to variations of the capacitive elements 321 and 322 or due to a parasitic capacitance. The solid-state imaging element 200 in the third embodiment is different from that in the first embodiment in that the PRNU is ameliorated by lowering the power supply of the FD reset transistor 313 at the time of readout.

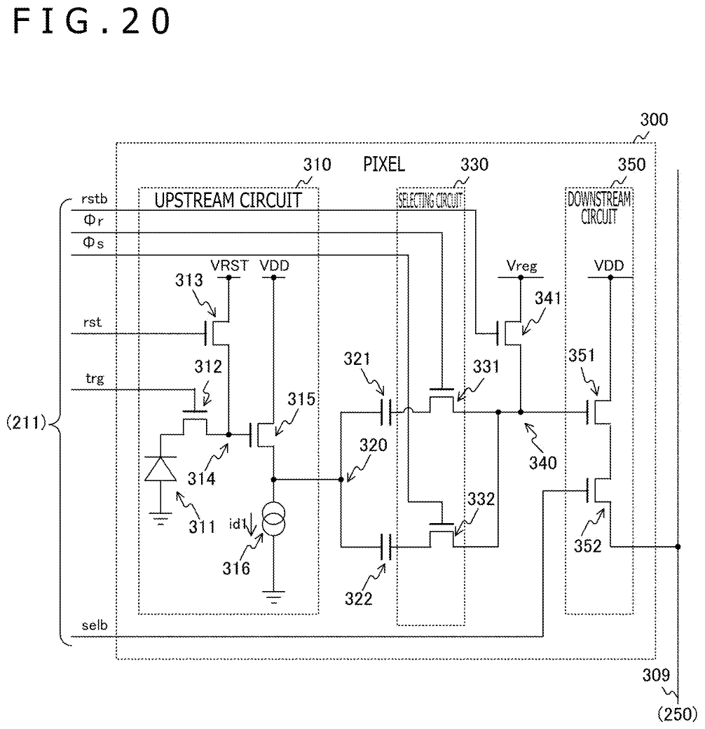

FIG. 20 is a circuit diagram depicting a configuration example of the pixel 300 in the third embodiment of the present technology. The pixels 300 in the third embodiment are different from those in the first embodiment in that the power supply of the FD reset transistor 313 is separated from the power supply voltage VDD of each pixel 300.

A drain of the FD reset transistor 313 in the third embodiment is connected to a reset power supply voltage VRST. For example, the reset power supply voltage VRST is controlled by the timing control circuit 212. Note that the timing control circuit 212 is an example of a control circuit described in claims.

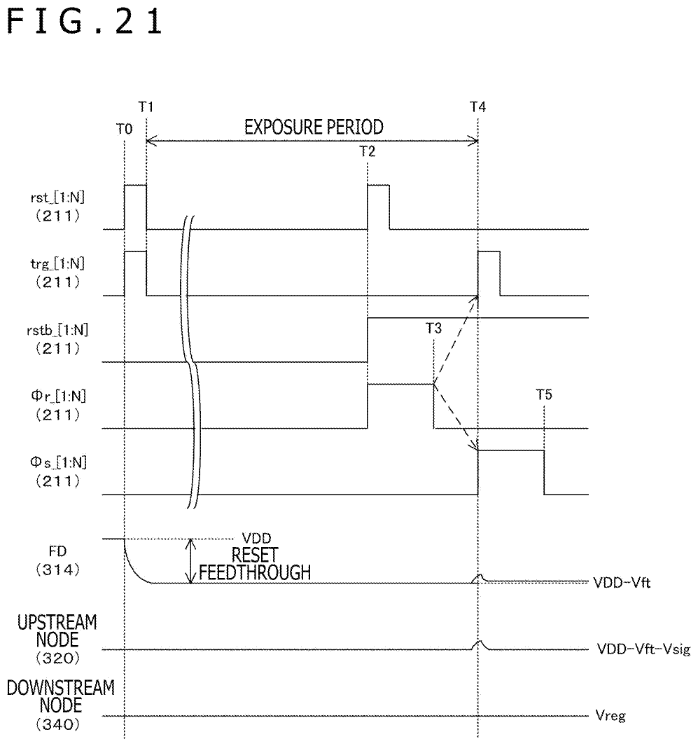

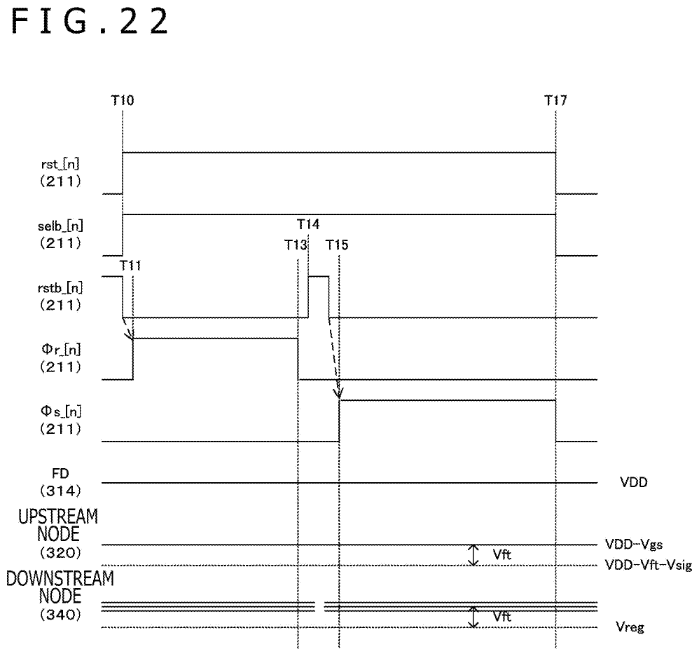

Here, with reference to FIG. 21 and FIG. 22, worsening of the PRNU in the pixel 300 in the first embodiment is considered. In the first embodiment, as illustrated in FIG. 21, at timing T0 immediately before the start of exposure, the potential of the FD 314 falls due to a reset feedthrough of the FD reset transistor 313. It is supposed that this variation amount is Vft.

Since the power supply voltage of the FD reset transistor 313 is VDD in the first embodiment, at timing TO, the potential of the FD 314 varies from VDD to VDD-Vft. In addition, the potential of the upstream node 320 at the time of exposure becomes VDD-Vft-Vsig.

In addition, in the first embodiment, as illustrated in FIG. 22, the FD reset transistor 313 transitions to the ON state at the time of readout, and the FD 314 is fixed to the power supply voltage VDD. Due to the variation amount Vft of the FD 314, the potentials of the upstream node 320 and the downstream node 340 at the time of readout are shifted higher by approximately Vft. Note that, due to variations of the capacitance values of the capacitive elements 321 and 322 or due to a parasitic capacitance, shifted voltage amounts vary pixel by pixel, and this becomes the root cause of the worsening of the PRNU.

The shift amount of the downstream node 340 in a case where the shift amount of the upstream node 320 is Vft is represented by the following formula, for example.

{(Cs+δCs)/(Cs+δCs+Cp)}*Vft Formula 4

In the formula above, Cs is the capacitance value of the capacitive element 322 on the signal-level side, and δCs is a variation of Cs. Cp is the capacitance value of a parasitic capacitance of the downstream node 340.

Formula 4 can approximate to the following formula.

$$\{ 1 - ( δ Cs / Cs ) * ( Cp / Cs ) \} * V ft \qquad Formula 5$$

From Formula 5, variations of the downstream node 340 can be represented by the following formula.

$$\{ ( δ Cs / Cs ) * ( Cp / Cs ) \} * V ft \qquad Formula 6$$

Supposing that (δCs/Cs) is 10⁻², (Cp/Cs) is 10⁻¹, and Vft is 400 millivolts (mV), the PRNU is 400 μVrms according to Formula 6, and has a relatively large value.

In particular, when the kTC noise at the time of sample-holding of the input-referred capacitance is to be reduced, the charge voltage conversion efficiency of the FD 314 needs to be increased. The capacitance of the FD 314 has to be reduced to increase the charge voltage conversion efficiency, but the variation amount Vft increases as the capacitance of the FD 314 is reduced, and can be several hundred millivolts (mV). In this case, according to Formula 6, the influence of the PRNU can be too significant to be ignored.

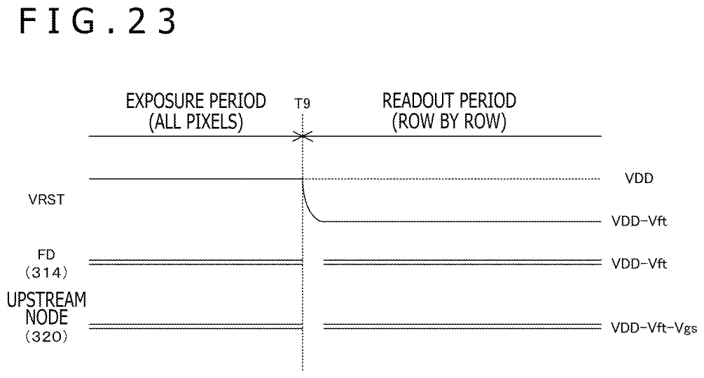

FIG. 23 is a timing chart depicting an example of voltage control in the third embodiment of the present technology.

In the row-by-row readout period at and after timing T9, the timing control circuit 212 controls the reset power supply voltage VRST such that it has a value different from that in an exposure period.

For example, in the exposure period, the timing control circuit 212 switches the reset power supply voltage VRST to the same value as the power supply voltage VDD. On the other hand, in the readout period, the timing control circuit 212 lowers the reset power supply voltage VRST to VDD−Vft. That is, in the readout period, the timing control circuit 212 lowers the reset power supply voltage VRST by an amount substantially matching the variation amount Vft caused by a reset feedthrough. With this control, it is possible to cause reset levels of the FD 314 at the time of exposure and at the time of readout to match each other.

With the control of the reset power supply voltage VRST, as illustrated in the figure, it is possible to reduce voltage variation amounts of the FD 314 and the upstream node 320. This can suppress worsening of the PRNU caused by variations of the capacitive elements 321 and 322 and a parasitic capacitance.

Note that the first to third modification examples of the first embodiment or the second embodiment can also be applied to the third embodiment.

Since the timing control circuit 212 lowers the reset power supply voltage VRST by the variation amount Vft caused by a reset feedthrough, at the time of readout, according to the third embodiment of the present technology as described above, it is possible to cause reset levels at the time of exposure and at the time of readout to match each other. As a result, worsening of the photo response non-uniformity (PRNU) can be suppressed.

### 4. Fourth Embodiment

Whereas signal levels are read out subsequently to reset levels for each frame in the first embodiment described above, there is a risk with this configuration that the photo response non-uniformity (PRNU) worsens due to variations of the capacitive elements 321 and 322 or a parasitic capacitance. The solid-state imaging element 200 in the fourth embodiment is different from that in the first embodiment in that the PRNU is ameliorated by switching a level to be held at the capacitive element 321 and a level to be held at the capacitive element 322 with each other for each frame.

The solid-state imaging element 200 in the fourth embodiment consecutively captures images of a plurality of frames in synchronization with vertical synchronizing signals. Frames at odd-numbered positions are referred to as “odd-numbered frames,” and frames at even-numbered positions are referred to as “even-numbered frames.” Note that the odd-numbered frame and the even-numbered frame are examples of a pair of frames described in claims.

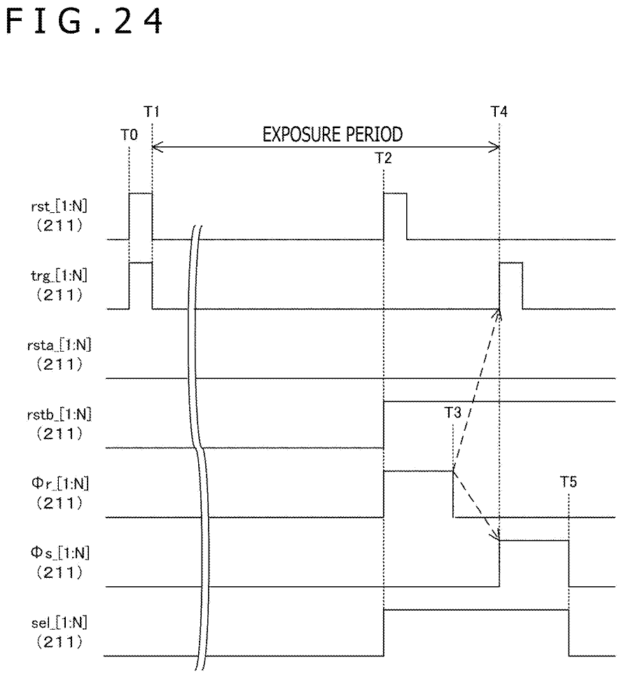

FIG. 24 is a timing chart depicting an example of the global shutter operation on an odd-numbered frame in the fourth embodiment. In an exposure period of the odd-numbered frame, by switching the selection signal Φs to the high level subsequently to the selection signal Φr, the upstream circuits 310 in the solid-state imaging element 200 cause the capacitive elements 321 to hold reset levels, and next cause the capacitive elements 322 to hold signal levels.

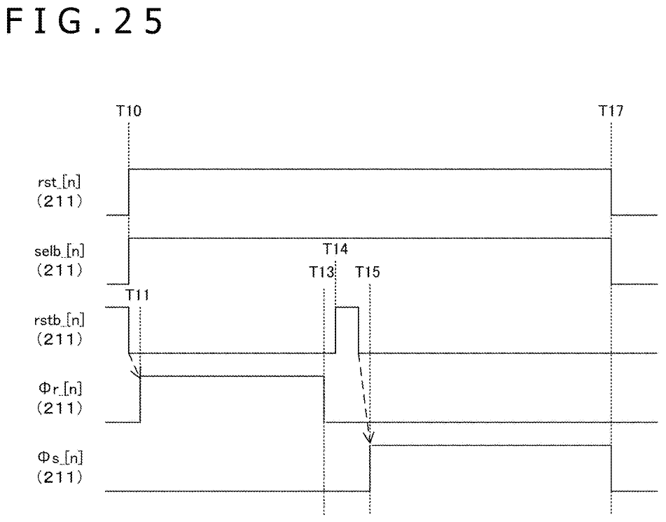

FIG. 25 is a timing chart depicting an example of the readout operation on an odd-numbered frame in the fourth embodiment of the present technology. In the readout period of the odd-numbered frame, by switching the selection signal Φs to the high level subsequently to the selection signal Φr, the downstream circuits 350 in the solid-state imaging element 200 read out the signal levels subsequently to the reset levels.

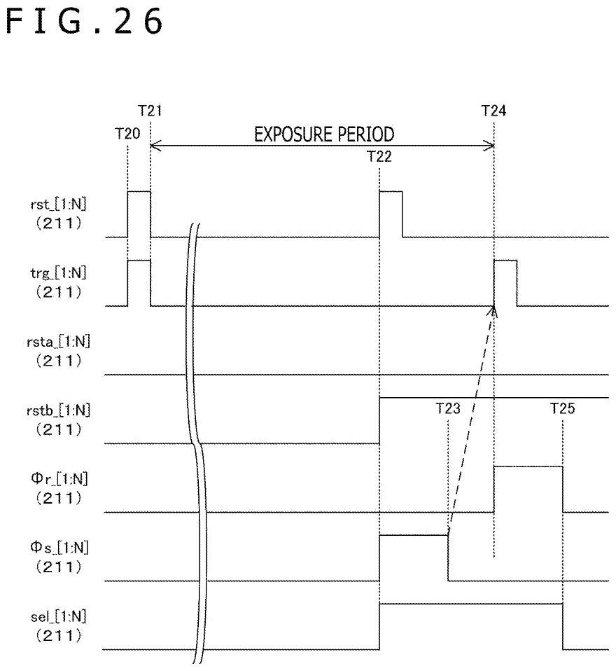

FIG. 26 is a timing chart depicting an example of the global shutter operation on an even-numbered frame in the fourth embodiment. In an exposure period of the even-numbered frame, by switching the selection signal Φr to the high level subsequently to the selection signal Φs, the upstream circuits 310 in the solid-state imaging element 200 cause the capacitive elements 322 to hold reset levels, and next cause the capacitive elements 321 to hold signal levels.

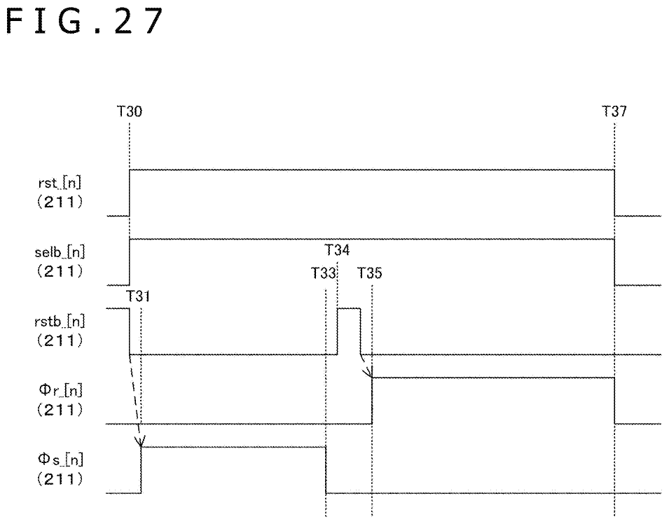

FIG. 27 is a timing chart depicting an example of the readout operation on an even-numbered frame in the fourth embodiment of the present technology. In the readout period of the even-numbered frame, by switching the selection signal Φr to the high level subsequently to the selection signal Φs, the downstream circuits 350 in the solid-state imaging element 200 read out the signal levels subsequently to the reset levels.

As illustrated in FIG. 24 and FIG. 26, opposite levels are held at the capacitive elements 321 and 322 for the even-numbered frame and for the odd-numbered frame. As a result, polarities of the PRNU also become opposite for the even-numbered frame and for odd-numbered frame. The downstream column signal processing circuit 260 determines the arithmetic mean of the odd-numbered frame and the even-numbered frame. As a result, the PRNU with the opposite polarities can cancel out each other.

This control is control effective for imaging of videos or addition of frames. In addition, this does not require addition of elements to the pixels 300, and can be realized only by a change of the drive scheme.

Note that the first to third modification examples of the first embodiment or the second or third embodiment can also be applied to the fourth embodiment.

Since levels to be held at the capacitive elements 321 and levels to be held at the capacitive elements 322 are made opposite for an odd-numbered frame and for an even-numbered frame in the fourth embodiment of the present technology as described above, polarities of the PRNU can be made opposite for the odd-numbered frame and for the even-numbered frame. By the column signal processing circuit 260 adding these odd-numbered frame and even-numbered frame, worsening of the PRNU can be suppressed.

### 5. Fifth Embodiment

In the first embodiment described above, the column signal processing circuit 260 determines the differences between reset levels and signal levels for each column. However, there is a risk with this configuration that, when light with very high illuminance enters the pixels, charges overflow from the photoelectric converting elements 311, which undesirably causes the sunspot phenomenon in which the luminance lowers and blackening occurs. The solid-state imaging element 200 in the fifth embodiment is different from that in the first embodiment in that it is determined for each pixel whether or not the sunspot phenomenon has occurred.

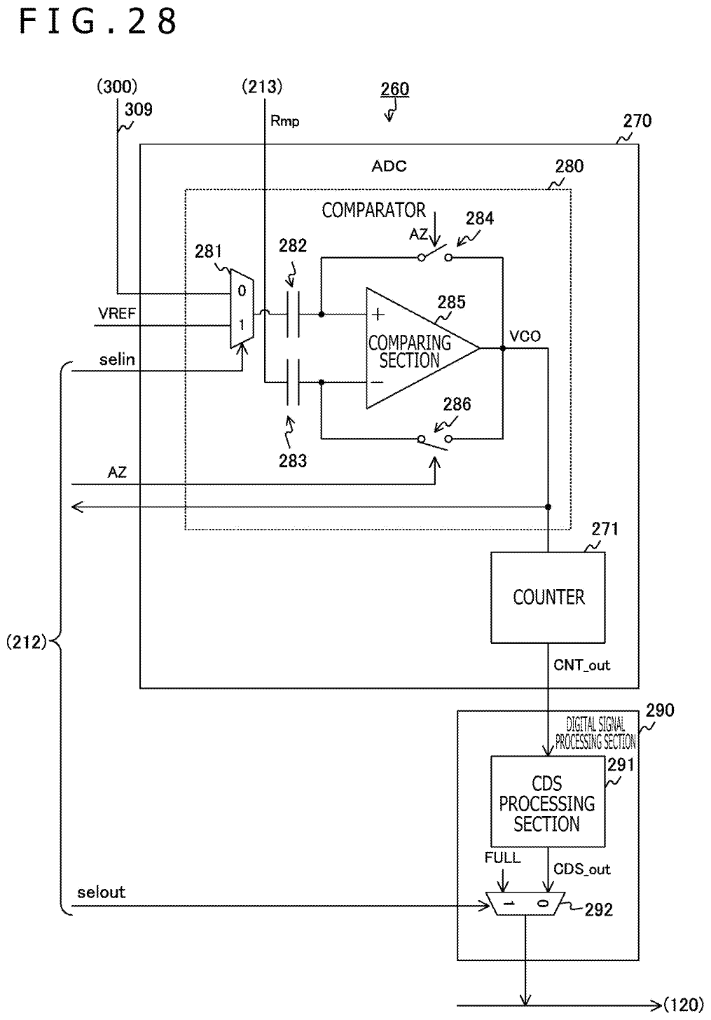

FIG. 28 is a circuit diagram depicting a configuration example of the column signal processing circuit 260 in the fifth embodiment of the present technology. A plurality of ADCs 270 and a digital signal processing section 290 are arranged in the column signal processing circuit 260 in the fifth embodiment. In addition, a plurality of CDS processing sections 291 and a plurality of selectors 292 are arranged in the digital signal processing section 290. An ADC 270, a CDS processing section 291, and a selector 292 are provided for each column.

In addition, each ADC 270 includes a comparator 280 and a counter 271. The comparator 280 is configured to compare the level of the vertical signal line 309 and the ramp signal Rmp from the DAC 213 and output a comparison result VCO. The comparison result VCO is supplied to the counter 271 and the timing control circuit 212. The comparator 280 includes a selector 281, capacitive elements 282 and 283, auto zero switches 284 and 286, and a comparing section 285.

The selector 281 is configured to connect, with a non-inversion input terminal (+) of the comparing section 285, any of the vertical signal line 309 of the corresponding column and a node with a predetermined reference voltage VREF via the capacitive element 282 according to an input side selection signal selin. The input side selection signal selin is supplied from the timing control circuit 212. Note that the selector 281 is an example of an input side selector described in claims.

The comparing section 285 is configured to compare the respective levels of the non-inversion input terminal (+) and an inversion input terminal (−) and output the comparison result VCO to the counter 271. The inversion input terminal (−) receives input of the ramp signal Rmp via a capacitive element 283.

The auto zero switch 284 is configured to short-circuit the non-inversion input terminal (+) and the output terminal of the comparison result VCO according to an auto zero signal Az from the timing control circuit 212. The auto zero switch 286 is configured to short-circuit the inversion input terminal (−) and the output terminal of the comparison result VCO according to the auto zero signal Az.

The counter 271 is configured to perform counting with a count until the comparison result VCO is inverted and output, to the CDS processing section 291, a digital signal CNT_out representing the count.

The CDS processing section 291 is configured to perform CDS processing on the digital signal CNT_out. The CDS processing section 291 calculates the difference between the digital signal CNT_out corresponding to the reset level and the digital signal CNT_out corresponding to the signal level, and outputs the difference as CDS_out to the selector 292.

The selector 292 is configured to output, as pixel data of the corresponding column, any of the digital signal CDS_out that has been subjected to the CDS processing and a full-code digital signal FULL according to an output side selection signal selout from the timing control circuit 212. Note that the selector 292 is an example of an output side selector described in claims.

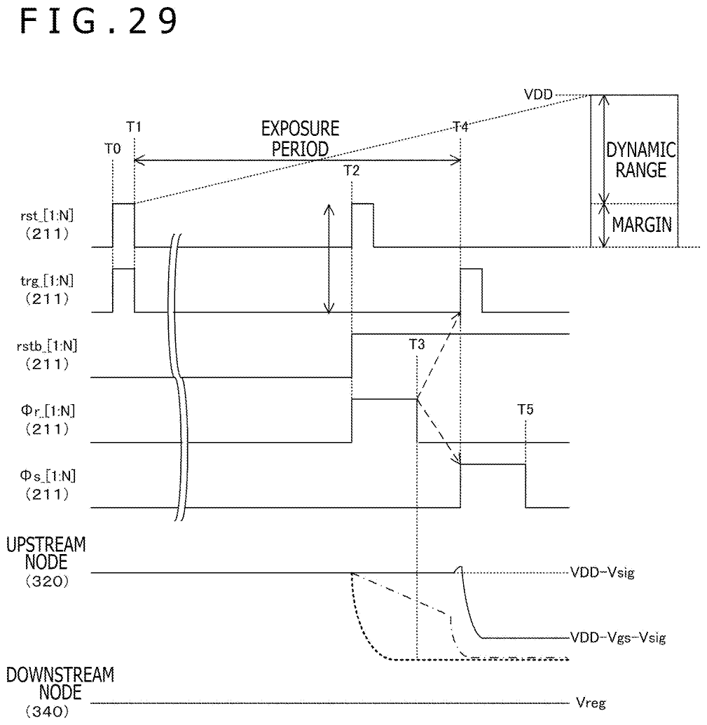

FIG. 29 is a timing chart depicting an example of the global shutter operation in the fifth embodiment of the present technology. The transistor control method at the time of global shutter in the fifth embodiment is similar to that in the first embodiment.

Here, it is supposed that light with very high illuminance has entered the pixel 300. In this case, the charge of the photoelectric converting element 311 becomes full, the charge overflows from the photoelectric converting element 311 to the FD 314, and the potential of the FD 314 that has been subjected to FD resetting lowers. A dash-dotted line in the figure represents a potential variation of the FD 314 at the time when sunlight which is weak to the extent that the amount of an overflowing electric charge becomes relatively small has entered. A dotted line in the figure represents a potential variation of the FD 314 at the time when sunlight which is intense to the extent that the amount of an overflowing electric charge becomes relatively large has entered.

At the time when the weak sunlight has entered, the reset level lowers at timing T3 when FD resetting is completed, but the level has not fully lowered at the moment.

In contrast, at the time when the intense sunlight has entered, the reset level fully lowers undesirably at the time point of timing T3. In this case, since the signal level becomes the same as the reset level and their electric potential difference is “zero,” a digital signal that has been subjected to CDS processing becomes one with blackening as in a case of a dark environment undesirably. A phenomenon in which light with very high illuminance such as sunlight has entered but, despite this, the pixel blackens in such a manner is called the sunspot phenomenon or blooming.

In addition, if the level of the FD 314 of a pixel in which the sunspot phenomenon has occurred lowers excessively, it becomes impossible to ensure the operating point of the upstream circuit 310, and the current id1 of the current source transistor 316 varies. Since the current source transistor 316 of each pixel shares a connection to a power supply or a ground, when a current in a pixel has varied, a variation of the IR drop of the pixel influences the sample levels of other pixels undesirably. The pixel in which the sunspot phenomenon has occurred becomes an aggressor, and the pixels whose sample levels have varied due to the pixel become victims. As a result, streaking noise is generated.

Note that, in a case where the discharge transistors 317 are provided as in the second embodiment, an overflow charge is discharged to the side of the discharge transistor 317 in a pixel having a sunspot (blooming), and accordingly, the sunspot phenomenon is unlikely to occur. Note that, even if the discharge transistors 317 are provided, there is a possibility that charges partially flow to the FDs 314, and there is a possibility that it cannot be an eradicative measure against the sunspot phenomenon. Further, there are also disadvantages that, due to the addition of the discharge transistors 317, the ratio of effective area size/electric charge amount of each pixel lowers undesirably. Because of this, it is desirable that the sunspot phenomenon be suppressed without using the discharge transistors 317.

There are two possible methods of suppressing the sunspot phenomenon without using discharge transistors 317. The first method is to adjust the clip levels of the FDs 314. The second method is to determine whether or not the sunspot phenomenon has occurred at the time of readout, and output is replaced with a full code at the time when the sunspot phenomenon has occurred.

As for the first method, the high level of the FD reset signal rst in the figure (i.e., a gate of the FD reset transistor 313) is the power supply voltage VDD, and the low level corresponds to the clip level of the FD 314. In the first embodiment, the difference between the high level and the low level (i.e., the amplitude) is set to a value corresponding to the dynamic range. In contrast to this, in the fifth embodiment, the difference is adjusted to a value obtained by further adding a margin to the value. Here, the value corresponding to the dynamic range corresponds to the difference between the power supply voltage VDD and the potential of the FD 314 at the time when the digital signal becomes a full code.

By lowering the gate voltage of the FD reset transistor 313 at the time of the OFF state (the low level of the FD reset signal rst), it is possible to prevent a situation where there is not an operating point of the upstream amplification transistor 315 due to lowering of the FD 314 by blooming.

Note that the dynamic range changes depending on the analog gain of an ADC. When the analog gain is low, a large dynamic range is necessary; on the contrary, when the analog gain is high, a small dynamic range is sufficient. Because of this, the gate voltage of the FD reset transistor 313 at the time of the OFF state can also be changed depending on the analog gain.

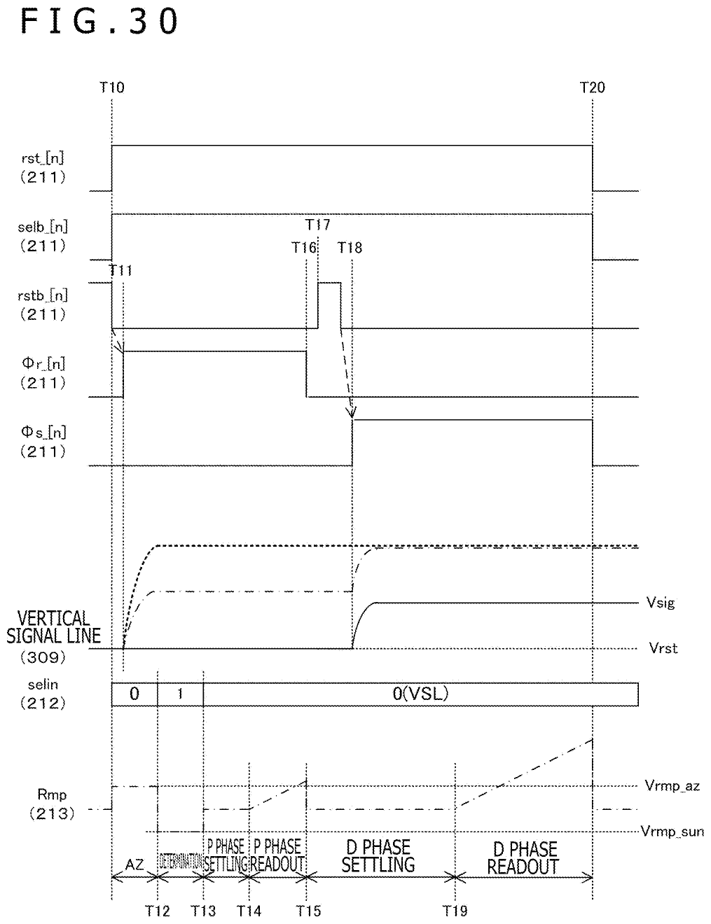

FIG. 30 is a timing chart depicting an example of the readout operation in the fifth embodiment of the present technology. When the selection signal Φr is switched to the high level at timing T11 immediately after timing T10 at the start of readout, the potential of the vertical signal line 309 of a pixel where sunlight has entered varies. A dash-dotted line in the figure represents a potential variation of the vertical signal line 309 at the time when weak sunlight has entered. A dotted line in the figure represents a potential variation of the vertical signal line 309 at the time when intense sunlight has entered.

In an auto zero period from timing T10 to timing T12, for example, the timing control circuit 212 supplies the input side selection signal selin of “zero,” and makes the comparing section 285 connected to the vertical signal line 309. In this auto zero period, the timing control circuit 212 performs auto zero by using the auto zero signal Az.

As for the second method, in a determination period from timing T12 to timing T13, for example, the timing control circuit 212 supplies the input side selection signal selin of “1.” Due to this input side selection signal selin, the comparing section 285 is disconnected from the vertical signal line 309, and is connected with a node with the reference voltage VREF. This reference voltage VREF is set to an expected value of the level of the vertical signal line 309 when blooming has not occurred. For example, supposing that the gate-source voltage of the downstream amplification transistor 351 is Vgs2, Vrst corresponds to Vreg−Vgs2. In addition, in the determination period, the DAC 213 lowers the level of the ramp signal Rmp from Vrmp_az to Vrmp_sun.

In addition, in a case where blooming has not occurred in the determination period, Vrst of the reset level of the vertical signal line 309 is almost the same as the reference voltage VREF, and differs little from that at the time when the potential of the inversion input terminal (+) of the comparing section 285 is auto zero. Meanwhile, since the level of the non-inversion input terminal (−) has lowered from Vrmp_az to Vrmp_sun, the comparison result VCO switches to the high level.

On the other hand, in a case where blooming has occurred, the reset level Vrst becomes sufficiently higher than the reference voltage VREF, and the comparison result VCO switches to the low level when the following formula is satisfied.

$$V rst - V REF > V rmp\_az - V rmp\_sun \qquad Formula 7$$

That is, the timing control circuit 212 can determine whether or not blooming has occurred, according to whether or not the comparison result VCO switches to the low level in the determination period.

Note that, in order to prevent the occurrence of an erroneous determination due to variations of the threshold voltage of the downstream amplification transistor 351, the IR drop difference of Vreg in a surface, or the like, it is necessary to ensure that there is a margin which is large to some extent for determination of Sun (the right-hand side of Formula 7).

At and after timing T13 after a lapse of the determination period, the timing control circuit 212 makes the comparing section 285 connected to the vertical signal line 309. In addition, after a lapse of the P phase settling period from timing T13 to timing T14, the P phase is read out in the period of timing T14 to timing T15. After a lapse of the D phase settling period from timing T15 to timing T19, the D phase is read out in the period from the timing T19 to timing T20.

In a case where it is determined that blooming has not occurred in the determination period, the timing control circuit 212 controls the selector 292 by using the output side selection signal selout, to output the digital signal CDS_out that has been subjected to CDS processing, as it is.

On the other hand, in a case where it is determined that blooming has occurred in the determination period, the timing control circuit 212 controls the selector 292 by using the output side selection signal selout, to cause a full code FULL to be output instead of the digital signal CDS_out that has been subjected to CDS processing. As a result, the sunspot phenomenon can be suppressed.

Note that the first to third modification examples of the first embodiment or the second to fourth embodiments can also be applied to the fifth embodiment.

Since, according to the fifth embodiment of the present technology, as described above, the timing control circuit 212 determines, on the basis of the comparison result VCO, whether or not the sunspot phenomenon has occurred and causes a full code to be output when the sunspot phenomenon has occurred, the sunspot phenomenon can be suppressed.

### 6. Sixth Embodiment

The vertical scanning circuit 211 performs control of causing all the rows (all the pixels) to be exposed simultaneously (i.e., the global shutter operation) in the first embodiment described above. However, in a case where the simultaneity of exposure is unnecessary and noise needs to be reduced, such as at the time of a test and at the time when analysis is performed, it is desirable to perform a rolling shutter operation. The solid-state imaging element 200 in the sixth embodiment is different from that in the first embodiment in that a rolling shutter operation is performed at the time of a test or the like.

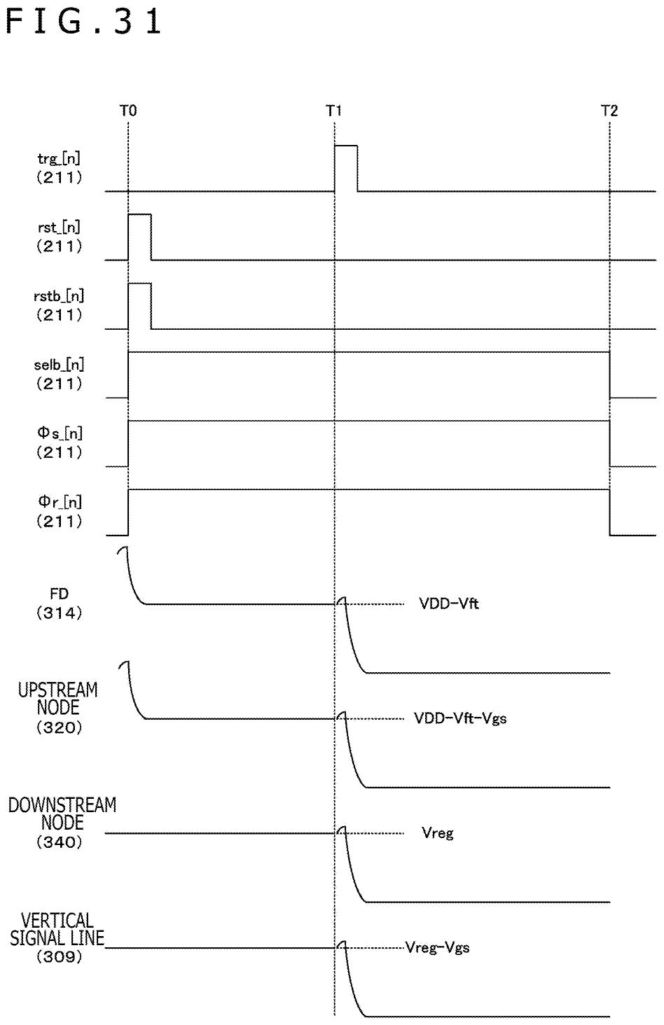

FIG. 31 is a timing chart depicting an example of the rolling shutter operation in the sixth embodiment of the present technology. The vertical scanning circuit 211 performs control of sequentially selecting a plurality of rows and causing exposure to be started. The figure depicts exposure control of the n-th row.

In the period from timing T0 to timing T2, the vertical scanning circuit 211 supplies the high-level downstream selection signal selb, selection signal Φr, and selection signal Φs to the n-th row. In addition, at timing T0 at the start of exposure, the vertical scanning circuit 211 supplies the high-level FD reset signal rst and downstream reset signal rstb to the n-th row over a pulse period. At timing T1 at the end of exposure, the vertical scanning circuit 211 supplies the transfer signal trg to the n-th row. With the rolling shutter operation in the figure, the solid-state imaging element 200 can generate image data with less noise.

Note that the solid-state imaging element 200 in the sixth embodiment performs the global shutter operation as in the first embodiment at the time of normal imaging.

In addition, the first to third modification examples of the first embodiment or the second to fifth embodiments can also be applied to the sixth embodiment.

Since the vertical scanning circuit 211 performs control of sequentially selecting a plurality of rows and causing exposure to be started for the selected rows (i.e., the rolling shutter operation) according to the sixth embodiment of the present technology as described above, image data with less noise can be generated.

### 7. Seventh Embodiment

In the first embodiment described above, the sources of the upstream source followers (the upstream amplification transistor 315 and the current source transistor 316) are connected to the power supply voltage VDD, and readout is performed row by row in a state where the source followers are in the ON state. However, there is a risk with this drive method that circuit noise of the upstream source followers at the time of row-by-row readout is propagated downstream and random noise increases. The solid-state imaging element 200 in the seventh embodiment is different from that in the first embodiment in that noise is reduced by switching the upstream source followers to the OFF state at the time of readout.

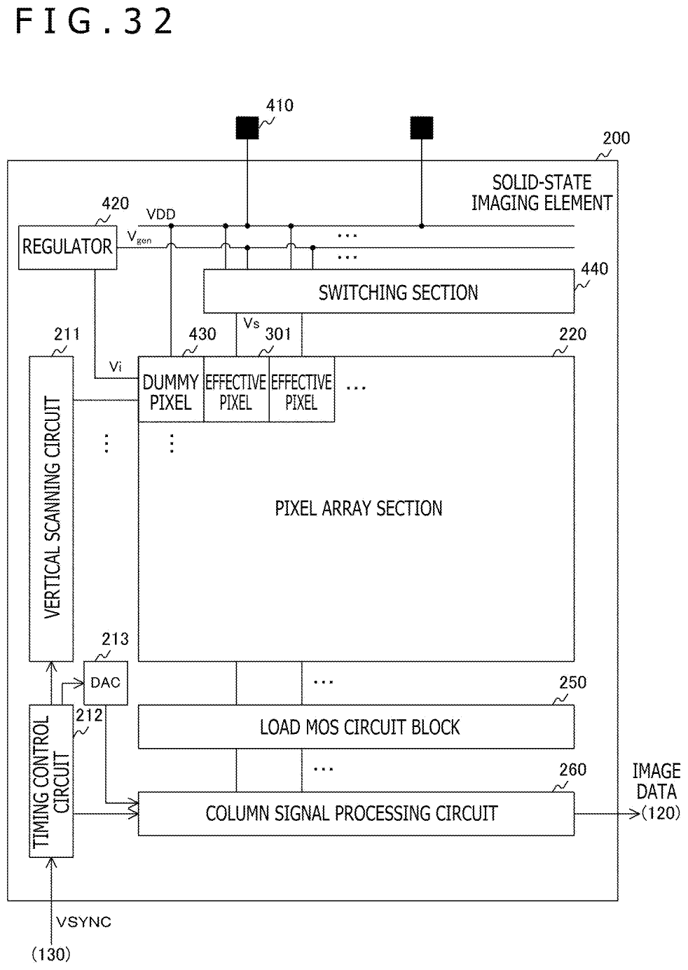

FIG. 32 is a block diagram depicting a configuration example of the solid-state imaging element 200 in the seventh embodiment of the present technology. The solid-state imaging element 200 in the seventh embodiment is different from that in the first embodiment in that the solid-state imaging element 200 in the seventh embodiment further includes a regulator 420 and a switching section 440. In addition, a plurality of effective pixels 301 and a predetermined number of dummy pixels 430 are arrayed in the pixel array section 220 in the seventh embodiment. The dummy pixels 430 are arrayed around the region where the effective pixels 301 are arrayed.

In addition, the power supply voltage VDD is supplied to each of the dummy pixels 430, and the power supply voltage VDD and a source voltage Vs are supplied to each of the effective pixels 301. Signal lines for supplying the power supply voltages VDD to the effective pixels 301 are omitted in the figure. In addition, the power supply voltage VDD is supplied from a pad 410 outside the solid-state imaging element 200.

The regulator 420 is configured to generate a predetermined generation voltage V_{gen} on the basis of an input potential Vi from the dummy pixel 430 and supply the predetermined generation voltage V_{gen} to the switching section 440. The switching section 440 is configured to select either the power supply voltage VDD from the pad 410 or the generation voltage V_{gen} from the regulator 420 and supply the selected one to each of the columns of the effective pixels 301 as the source voltage Vs.

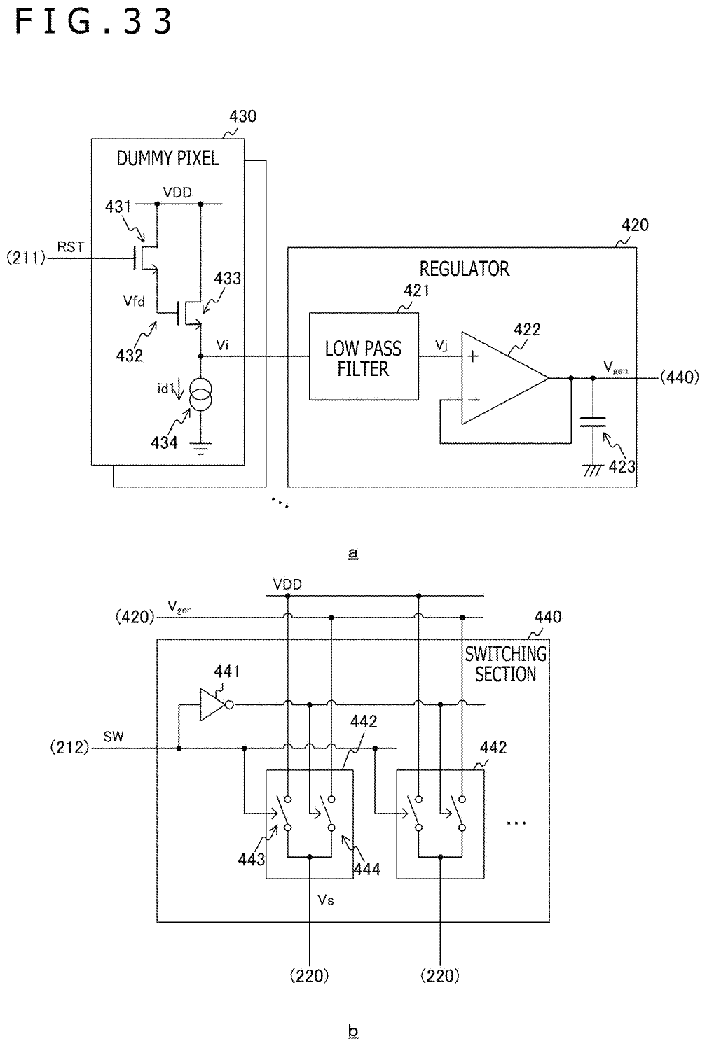

FIG. 33 is a circuit diagram depicting a configuration example of the dummy pixel 430, the regulator 420, and the switching section 440 in the seventh embodiment of the present technology. “a” in the figure is a circuit diagram of the dummy pixel 430 and the regulator 420, and “b” in the figure is a circuit diagram of the switching section 440.

As illustrated in “a” in the figure, the dummy pixel 430 includes a reset transistor 431, an FD 432, an amplification transistor 433, and a current source transistor 434. The reset transistor 431 is configured to initialize the FD 432 according to a reset signal RST from the vertical scanning circuit 211. The FD 432 is configured to accumulate a charge and generate a voltage according to the electric charge amount. The amplification transistor 433 is configured to amplify the level of the voltage of the FD 432 and supply the voltage to the regulator 420 as an input voltage Vi.

In addition, sources of the reset transistor 431 and the amplification transistor 433 are connected to the power supply voltage VDD. The current source transistor 434 is connected to the drain of the amplification transistor 433. Under the control of the vertical scanning circuit 211, the current source transistor 434 supplies the current id1.

The regulator 420 includes a low pass filter 421, a buffer amplifier 422, and a capacitive element 423. The low pass filter 421 is configured to allow components in a low frequency band lower than a predetermined frequency in a signal with the input voltage Vi to pass as an output voltage Vj.

A non-inversion input terminal (+) of the buffer amplifier 422 receives input of the output voltage Vj. An inversion input terminal (−) of the buffer amplifier 422 is connected with an output terminal of the buffer amplifier 422. The capacitive element 423 is configured to hold, as V_{gen}, the voltage of the output terminal of the buffer amplifier 422. This V_{gen} is supplied to the switching section 440.

As illustrated in “b” in the figure, the switching section 440 includes an inverter 441 and a plurality of switching circuits 442. Each of the switching circuits 442 is arranged for a column of the effective pixels 301.

The inverter 441 is configured to invert a switching signal SW from the timing control circuit 212. This inverter 441 supplies the inverted signal to each of the switching circuits 442.

Each switching circuit 442 is configured to select either the power supply voltage VDD or the generation voltage V_{gen} and supply, as the source voltage Vs, the selected one to the corresponding column in the pixel array section 220. The switching circuit 442 includes switches 443 and 444. The switch 443 is configured to open and close a path between a node with the power supply voltage VDD and the corresponding column according to the switching signal SW. The switch 444 is configured to open and close a path between a node with the generation voltage V_{gen} and the corresponding column according to the inverted signal of the switching signal SW.

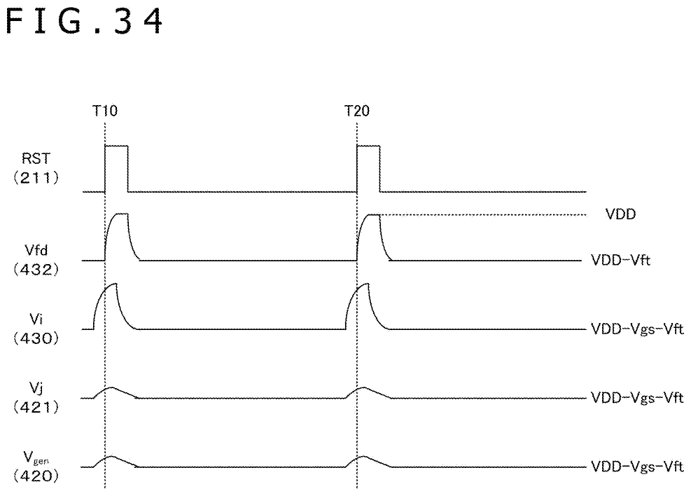

FIG. 34 is a timing chart depicting an example of operations of the dummy pixel 430 and the regulator 420 in the seventh embodiment of the present technology. At timing T10 immediately before readout of a row, the vertical scanning circuit 211 supplies the reset signal RST which is at the high level (here, with the power supply voltage VDD) to each of the dummy pixels 430. A potential Vfd of the FD 432 in the dummy pixel 430 is initialized to the power supply voltage VDD. Then, when the reset signal RST has been switched to the low level, the potential Vfd varies to VDD−Vft due to a reset feedthrough.

In addition, the input voltage Vi lowers to VDD-Vgs-Vsig after the resetting. Due to passage through the low pass filter 421, Vj and V_{gen} become substantially constant voltages.

At and after timing T20 immediately before readout of the next row, similar control is performed row by row, and the predetermined generation voltage V_{gen} is supplied.

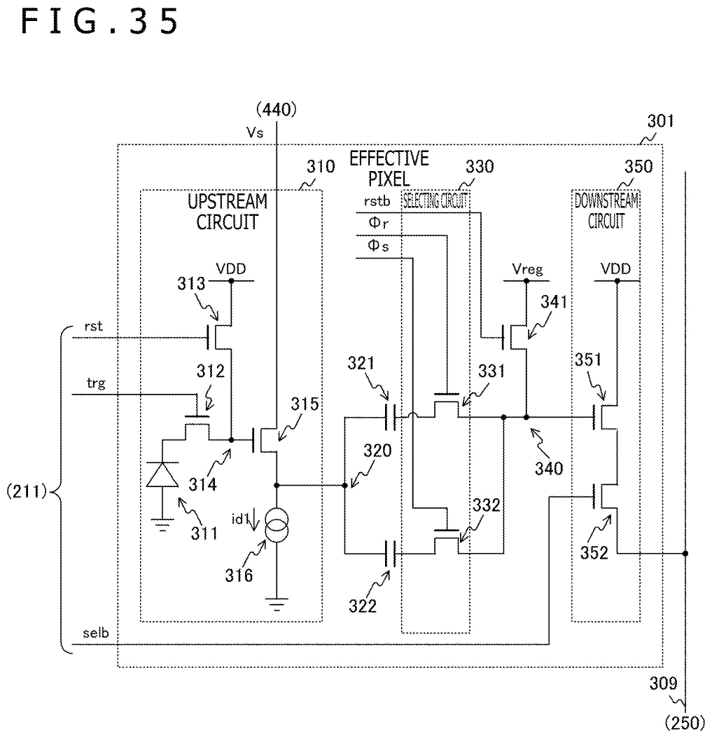

FIG. 35 is a circuit diagram depicting a configuration example of the effective pixel 301 in the seventh embodiment of the present technology. The circuit configurations of the effective pixels 301 are similar to those of the pixels 300 in the first embodiment except that the source voltage Vs from the switching section 440 is supplied to the source of the upstream amplification transistor 315.

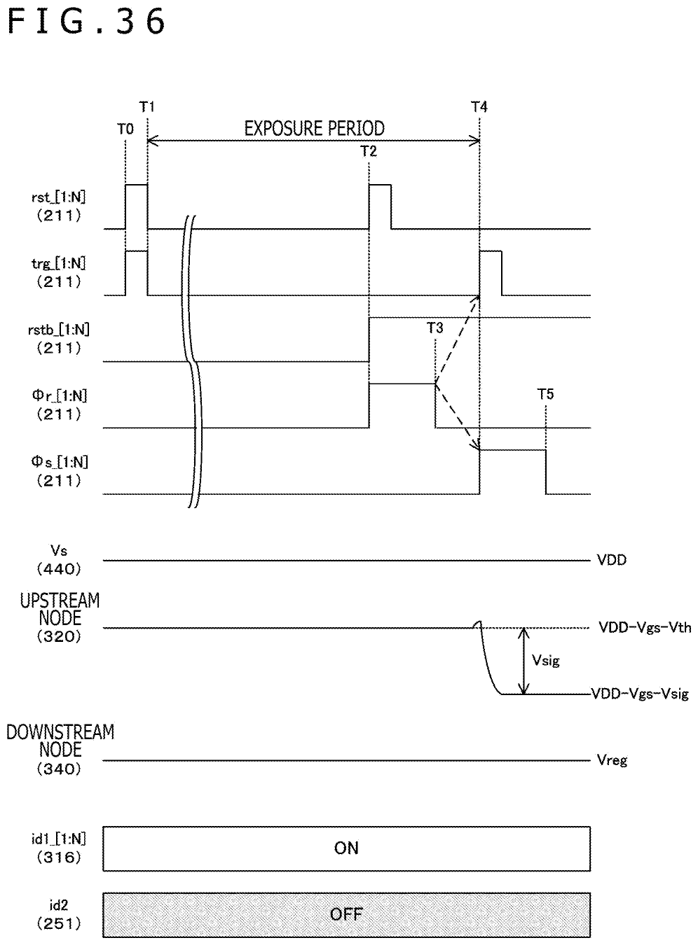

FIG. 36 is a timing chart depicting an example of the global shutter operation in the seventh embodiment of the present technology. In the seventh embodiment, when all the pixels are exposed simultaneously, the switching section 440 selects the power supply voltage VDD, and supplies the power supply voltage VDD as the source voltage Vs. In addition, the voltage of the upstream node lowers from VDD−Vgs−Vth to VDD−Vgs−Vsig at timing T4. Here, Vth is a threshold voltage of the transfer transistor 312.

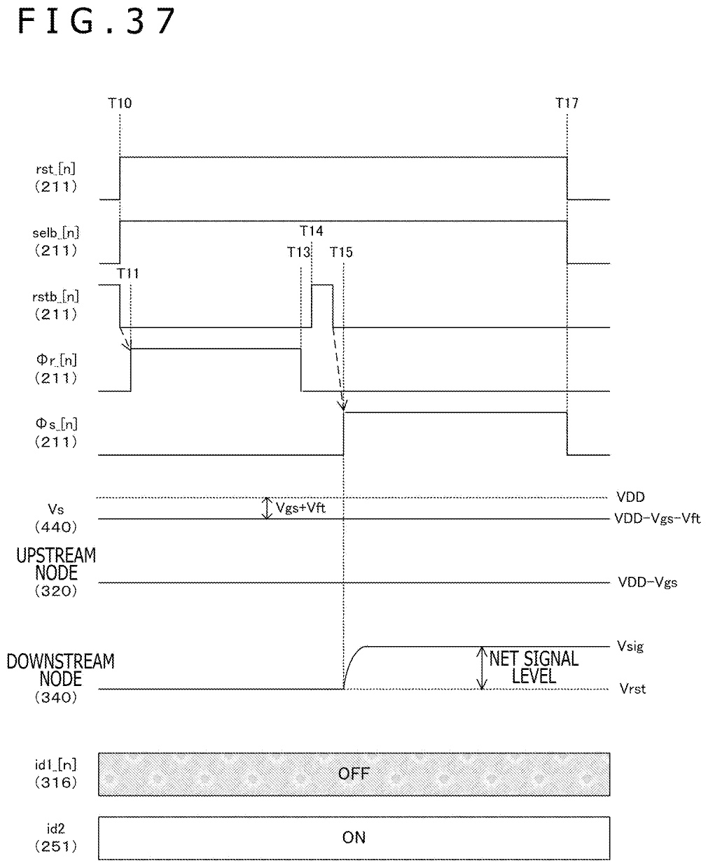

FIG. 37 is a timing chart depicting an example of the readout operation in the seventh embodiment of the present technology. In the seventh embodiment, at the time of readout, the switching section 440 selects the generation voltage V_{gen}, and supplies the generation voltage V_{gen} as the source voltage Vs. This generation voltage V_{gen} is adjusted to VDD−Vgs−Vft. In addition, in the seventh embodiment, the vertical scanning circuit 211 controls the current source transistors 316 of all the rows (all the pixels) to stop the supply of the current id1.

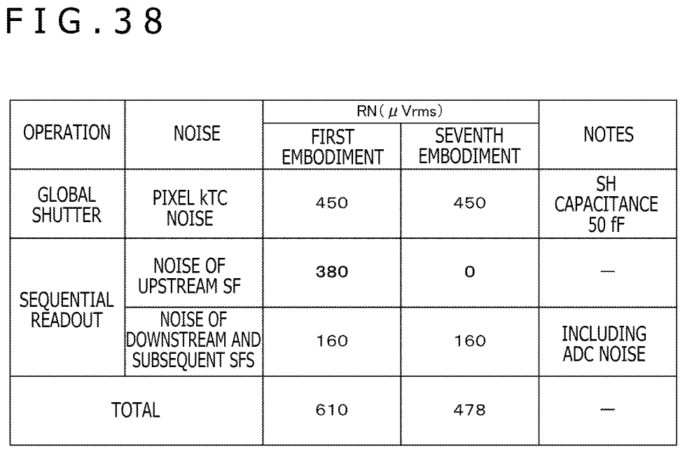

FIG. 38 is a figure for explaining effects in the seventh embodiment of the present technology. In the first embodiment, in row-by-row readout, the source followers (the upstream amplification transistors 315 and the current source transistors 316) of readout-subject pixels 300 are switched to the ON state. However, there is a risk with this drive method that circuit noise of the upstream source followers is propagated downstream (the capacitive elements, downstream source followers, or ADCs) and readout noise increases.

For example, in the first embodiment, kTC noise that is generated in pixels at the time of the global shutter operation is 450 (μVrms) as illustrated in the figure. In addition, noise that is generated in the upstream source followers (the upstream amplification transistors 315 and the current source transistors 316) at the time of row-by-row readout is 380 (μVrms). Noise that is generated at and after the downstream source followers is 160 (μVrms). Thus, the total noise is 610 (μVrms). In such a manner, in the first embodiment, the amount of contribution of the noise of the upstream source followers to the total value of noise is relatively large.

In order to reduce the noise of the upstream source followers, in the seventh embodiment, the voltage (Vs) that can be adjusted is supplied to the sources of the upstream source followers as described before. At the time of the global shutter (exposure) operation, the switching section 440 selects the power supply voltage VDD, and supplies the power supply voltage VDD as the source voltage Vs. Then, after the end of exposure, the switching section 440 switches the source voltage Vs to VDD−Vgs−Vft. In addition, the timing control circuit 212 switches the upstream current source transistors 316 to the ON state at the time of the global shutter (exposure) operation, and switches the upstream current source transistors 316 to the OFF state after the end of exposure.

With the control described above, as illustrated in FIG. 36 and FIG. 37, the potentials of the upstream nodes at the time of the global shutter operation and at the time of row-by-row readout match, and the PRNU can be ameliorated. In addition, since the upstream source followers are switched to the OFF state at the time of row-by-row readout, circuit noise of the source followers is not generated, and the circuit noise is 0 (μVrms), as illustrated in FIG. 38. Note that the upstream amplification transistors 315 among the upstream source followers are in the ON state.

Since the upstream source followers are switched to the OFF state at the time of readout according to the seventh embodiment of the present technology as described above, noise that is generated in the source followers can be reduced.

### 8. Eighth Embodiment

Whereas exposure is performed by the global shutter scheme in the first embodiment described above, it is difficult with this configuration to further improve the image quality or the readout speed. The solid-state imaging element 200 in this eighth embodiment is different from the first embodiment in that a low-noise fast rolling shutter operation is realized.

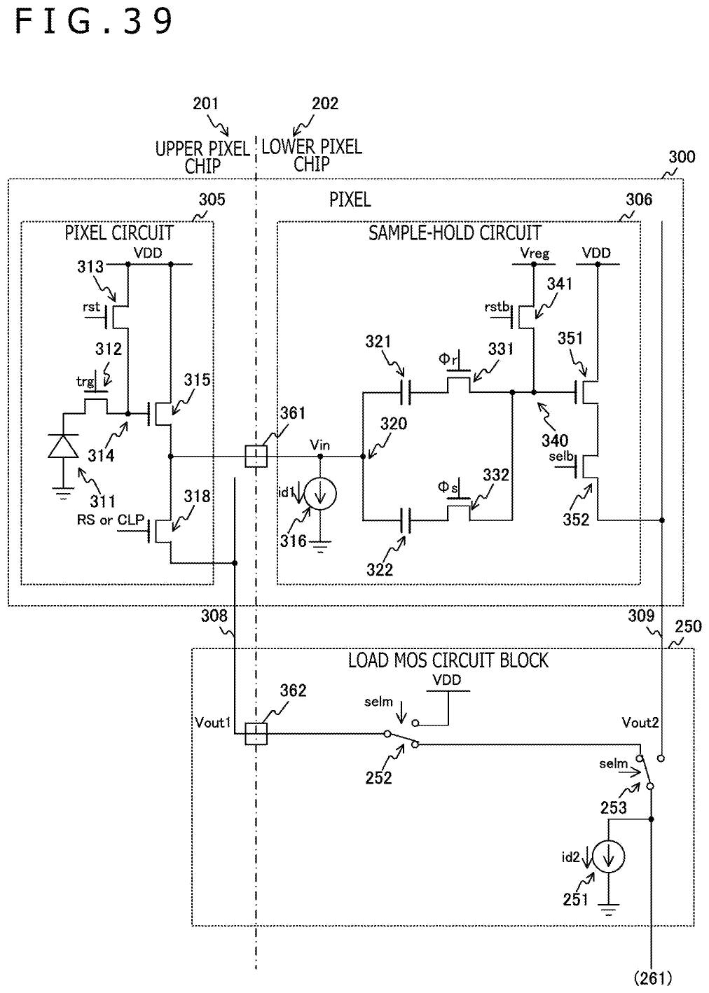

FIG. 39 is a circuit diagram depicting configuration examples of the pixel 300 and the load MOS circuit block 250 in the eighth embodiment of the present technology. Each pixel 300 in the eighth embodiment includes a pixel circuit 305 and a sample-hold circuit 306.

The pixel circuit 305 includes the photoelectric converting element 311, the transfer transistor 312, the FD reset transistor 313, the FD 314, the upstream amplification transistor 315, and a selection transistor 318. In addition, the sample-hold circuit 306 includes the current source transistor 316, the capacitive elements 321 and 322, the selection transistors 331 and 332, the downstream reset transistor 341, the downstream amplification transistor 351, and the downstream selection transistor 352.

The connection configuration of elements other than the selection transistor 318 in the pixel 300 is similar to that in the first embodiment illustrated in FIG. 3.

In addition, in the pixel array section 220 in the eighth embodiment in FIG. 39, two vertical signal lines such as vertical signal lines 308 and 309 are placed for each column. The selection transistor 318 is configured to output, as an output signal Vout1 and to the load MOS circuit block 250 via the vertical signal line 308, a pixel signal with a voltage amplified by the upstream amplification transistor 315 according to a control signal from the vertical scanning circuit 211. As the control signal, RS or CLP from the vertical scanning circuit 211 is supplied to a gate of the selection transistor 318.

In addition, the upstream amplification transistor 315 outputs, as an input signal Vin, a pixel signal to the upstream node 320. The sample-hold circuit 306 causes the capacitive elements 321 and 322 to hold a reset level and a signal level of the input signal Vin, and outputs, as an output signal Vout2, the reset level and the signal level of the input signal Vin to the load MOS circuit block 250 via the vertical signal line 309.

In addition, in the load MOS circuit block 250, a current supply switch 252 and a changeover switch 253 are further arranged for each column. The current supply switch 252 is configured to connect the vertical signal line 308 to any one of the power supply voltage VDD and the changeover switch 253 according to a control signal selm from the vertical scanning circuit 211. The changeover switch 253 is configured to select any one of the output signal Vout1 from the current supply switch 252 and the output signal Vout2 from the vertical signal line 309 according to the control signal selm and output the selected one to the load MOS transistor 251 and the ADC 261.

In addition, in the eighth embodiment, any one of a rolling shutter mode to sequentially select rows and start exposure for the selected rows and a global shutter mode to simultaneously start exposure for all the pixels is selected for the solid-state imaging element 200. In a case where the rolling shutter mode is selected, the vertical scanning circuit 211 sequentially drives rows, and causes exposure to be performed by a rolling shutter scheme. The pixel circuit 305 generates a pixel signal, and outputs, as the output signal Vout1, the pixel signal via the vertical signal line 308. The current supply switch 252 connects the vertical signal line 308 to the changeover switch 253, and the changeover switch 253 selects the output signal Vout1, and outputs the output signal Vout1 to the ADC 261.

In contrast, in a case where the global shutter mode is selected, the vertical scanning circuit 211 drives all the pixels, and causes expose to be performed by the global shutter scheme, as in the first embodiment. The pixel circuit 305 supplies, as the input signal Vin, a pixel signal to the sample-hold circuit 306. The sample-hold circuit 306 holds the input signal Vin, and outputs, as the output signal Vout2, the input signal Vin via the vertical signal line 309 according to the downstream selection signal selb. The current supply switch 252 connects the vertical signal line 308 to the power supply voltage VDD, and the changeover switch 253 selects the output signal Vout2, and outputs the output signal Vout2 to the ADC 261.

In addition, the solid-state imaging element 200 in the eighth embodiment includes the lower pixel chip 202 and the upper pixel chip 201 stacked on the lower pixel chip 202. For example, these chips are electrically connected to each other by Cu—Cu junctions. Note that they can also be connected to each other by vias or bumps, other than Cu—Cu junctions. For example, the pixel circuit 305 is arranged on the upper pixel chip 201, and the sample-hold circuit 306 and circuits in the load MOS circuit block 250 and in the following stages are arranged on the lower pixel chip 202. The pixel circuit 305 and the sample-hold circuit 306 are connected to each other by a Cu—Cu-junction connecting section 361. In addition, the vertical signal line 308 and the load MOS circuit block 250 are connected to each other by a Cu—Cu-junction connecting section 362. Note that, without stacking pixel chips, circuits and elements in the solid-state imaging element 200 can also be provided on a single semiconductor chip.

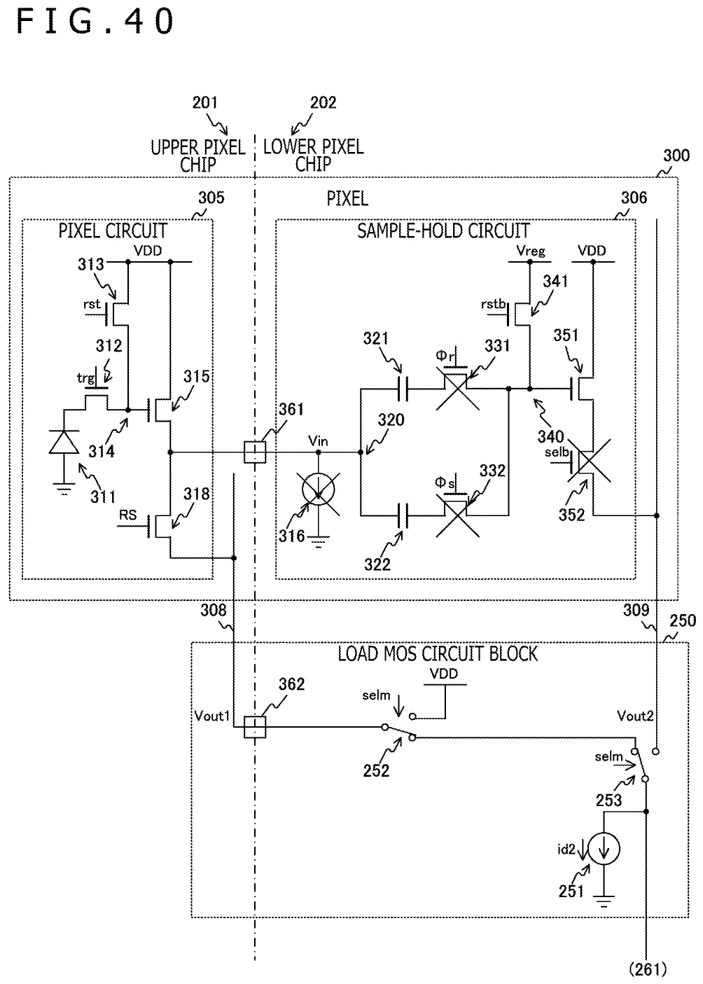

FIG. 40 is a figure depicting the states of the pixel 300 and the load MOS circuit block 250 in a rolling shutter mode in the eighth embodiment of the present technology. The control signal RS for sequentially selecting rows is supplied to the gate of the selection transistor 318. According to the control signal RS, the selection transistor 318 outputs, as the output signal Vout1, a pixel signal via the vertical signal line 308. The current supply switch 252 connects the vertical signal line 308 to the changeover switch 253, and the changeover switch 253 selects the output signal Vout1, and outputs the output signal Vout1 to the ADC 261.

In addition, in the sample-hold circuit 306, the current source transistor 316, the selection transistors 331 and 332, and the downstream selection transistor 352 are controlled to be in the OFF state. The downstream reset transistor 341 is controlled to be in the ON state. In the figure, cross marks represent that the transistors are in the OFF state.

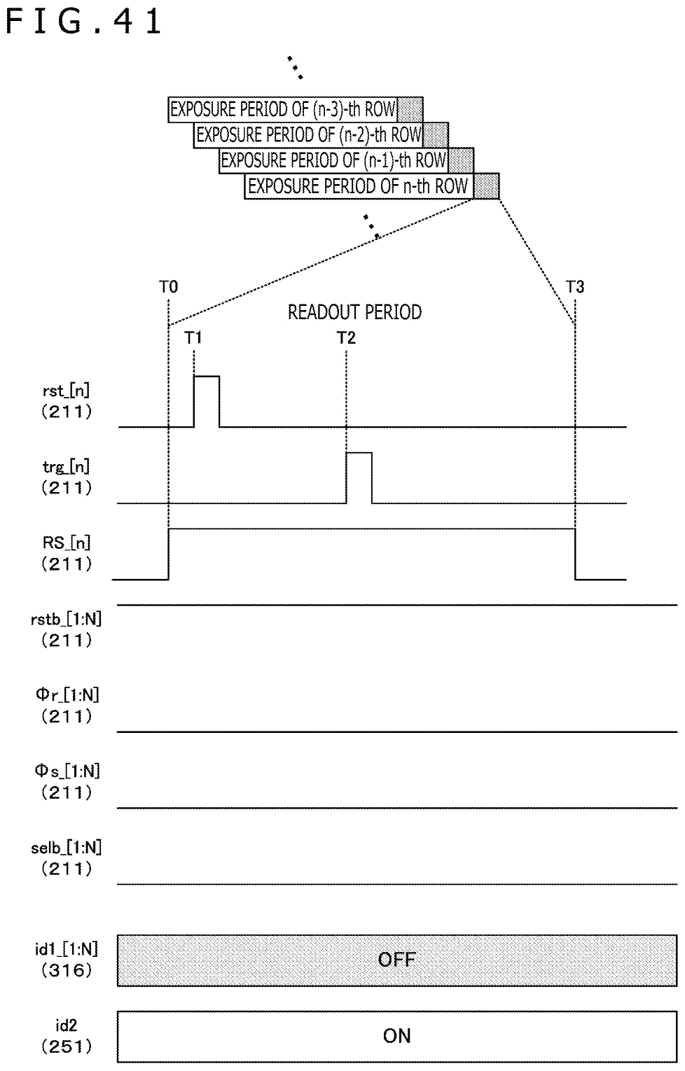

FIG. 41 is a timing chart depicting an example of an operation of the solid-state imaging element in the rolling shutter mode in the eighth embodiment of the present technology. As illustrated in the figure, the vertical scanning circuit 211 (not depicted) sequentially selects rows, and causes exposure to be started for the selected rows. At the end of exposure of a row, readout of the row is started. Gray portions in the figure represent readout periods. rst_[n], trg_[n], and RS_[n] represent signals for the n-th row.

It is supposed that a readout period of the n-th row is from T0 to T3. Over the period, the vertical scanning circuit 211 supplies the high-level control signal RS_[n]. In addition, over the pulse period from timing T1 in the period, the vertical scanning circuit 211 supplies the high-level reset signal rst_[n]. Immediately after that, the reset level of the n-th row is read out. Then, over the pulse period from timing T2 after the reset-level readout, the vertical scanning circuit 211 supplies the high-level transfer signal trg_[n]. Immediately after that, the signal level of the n-th row is read out.

The downstream reset signal rstb for all the pixels is controlled to be at the high level. The selection signals Φr and Φs for all the rows and the downstream selection signal selb are controlled to be at the low levels. The current id1 is not supplied from the current source transistors 316 in all the rows. On the other hand, the current id2 is supplied by the load MOS transistor 251 for all the columns.

As illustrated in FIG. 40 and FIG. 41, in the rolling shutter mode, the sample-hold circuit 306 is stopped, and the output signal Vout1 from the pixel circuit 305 is output by the changeover switch 253. Thus, kTC noise that is generated when the sample-hold circuit 306 performs sample-holding can be suppressed. In addition, since it is not necessary for the sample-hold circuit 306 to perform holding, the readout speed can be increased accordingly. In such a manner, in the rolling shutter mode, although there is a possibility that a rolling shutter distortion is generated, low-noise fast imaging can be performed.

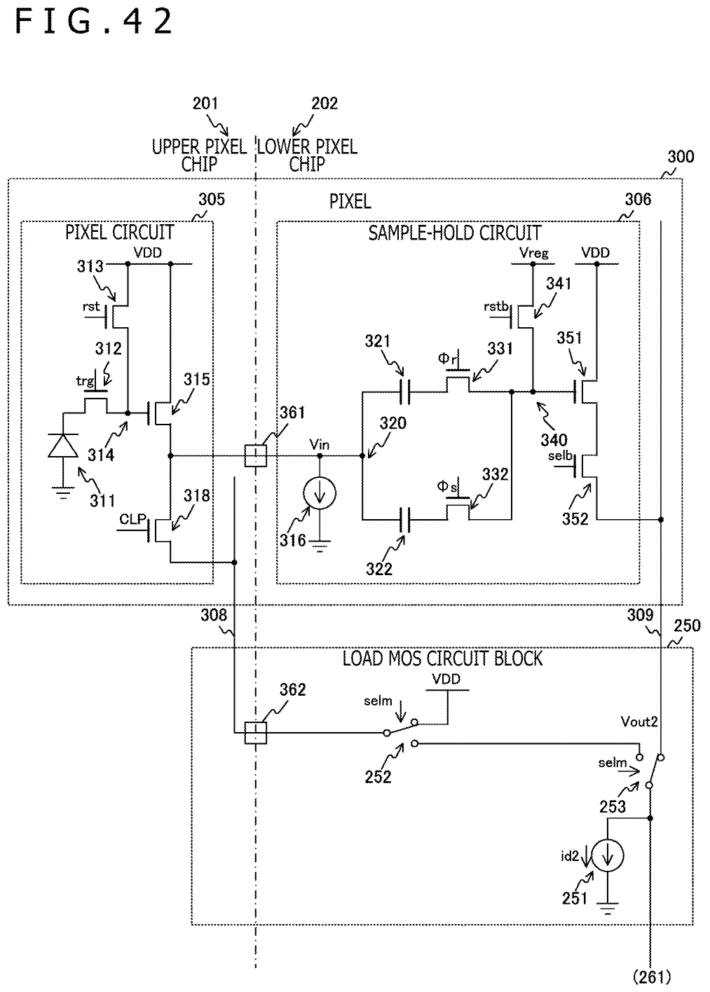

FIG. 42 is a figure depicting the states of the pixel 300 and the load MOS circuit block 250 in the global shutter mode in the eighth embodiment of the present technology. The control signal CLP for clipping the reset level of the input signal Vin is supplied to the gate of the selection transistor 318. In a reset level sample period, the vertical scanning circuit 211 switches the control signal CLP to a predetermined clip level. In periods other than the sample period, the control signal CLP is controlled to be at the low level.

In addition, the current supply switch 252 connects the vertical signal line 308 to the power supply voltage VDD, and the changeover switch 253 selects the output signal Vout2 from the sample-hold circuit 306, and outputs the output signal Vout2 to the ADC 261.

Control of the current supply switch 252 and the selection transistor 318 causes a current to flow along a path from the power supply voltage VDD through the current supply switch 252, the selection transistor 318, and the current source transistor 316 to the ground terminal. Owing to this current, in a case where the illuminance is very high, even if the reset level lowers, the level is kept (i.e., clipped) at or higher than a certain value according to CLP. As a result, the sunspot phenomenon, in which pixels blacken despite the entrance of light with very high illuminance, can be prevented. Note that a configuration in which the current supply switch 252 is not arranged can also be adopted in a case where it is not necessary to prevent the sunspot phenomenon.

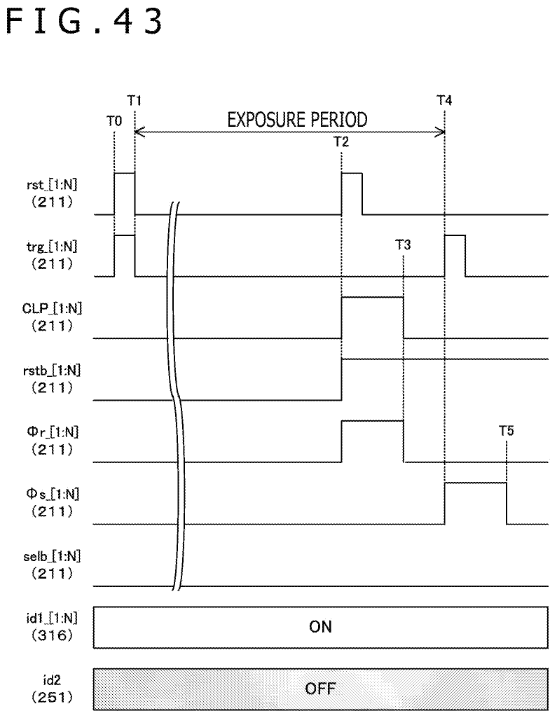

FIG. 43 is a timing chart depicting an example of an operation of the solid-state imaging element in the global shutter mode in the eighth embodiment of the present technology. The method of controlling each of rst, trg, rstb, Φr, Φs, selb, id1, and id2 is similar to that in the first embodiment illustrated in FIG. 5.

As illustrated in FIG. 43, in a period in which the selection signal Φr is at the high level from timing T2 to timing T3 (i.e., a reset level sample period), the vertical scanning circuit 211 controls the control signal CLP to be at a predetermined clip level. As a result, the reset level is clipped. In periods other than the sample period, the control signal CLP is controlled to be at the low level.

As illustrated in FIG. 42 and FIG. 43, in the global shutter mode, the sample-hold circuit 306 sample-holds the reset level and the signal level of an input signal from the pixel circuit 305. Thus, exposure can be performed by the global shutter scheme, and a rolling shutter distortion can be prevented.

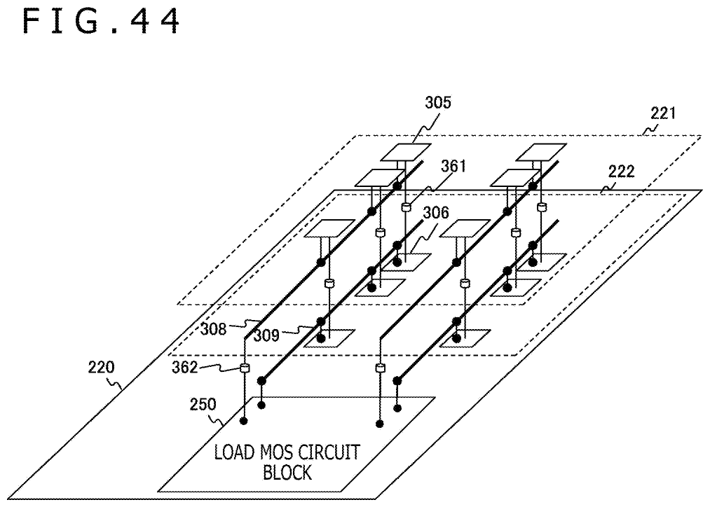

FIG. 44 is a figure depicting an example of an inter-chip connection state in the eighth embodiment of the present technology. The pixel circuit 305 is arranged for each pixel on the upper pixel array section 221, and the sample-hold circuit 306 is arranged on the lower pixel array section 222. The pixel circuit 305 is connected to the vertical signal line 308, and the sample-hold circuit 306 is connected to the vertical signal line 309. The pixel circuit 305 and the sample-hold circuit 306 immediately thereunder are connected to each other via the connecting section 361, and the vertical signal line 308 and the load MOS circuit block 250 are connected to each other via the connecting section 362. As illustrated in the figure, the numbers of the connecting sections 361 and the connecting sections 362 connecting the upper and lower chips are the same as the number of pixels and the number of columns, respectively.

Note that each of the second, third, fourth, fifth, and seventh embodiments can also be applied to the eighth embodiment.

Since the changeover switch 253 selects the output signal Vout1 from the pixel circuit 305 at the time when the rolling shutter mode is selected according to the eighth embodiment of the present technology as described above, a low-noise fast rolling shutter operation can be realized.

### Modification Example

Whereas the FD 314 and the sample-hold circuit 306 are provided for each pixel in the eighth embodiment described above, it is difficult with this configuration to reduce the circuit scale per pixel. The solid-state imaging element 200 in the modification example of the eighth embodiment is different from that in the eighth embodiment in that a plurality of pixels share the FD 314.

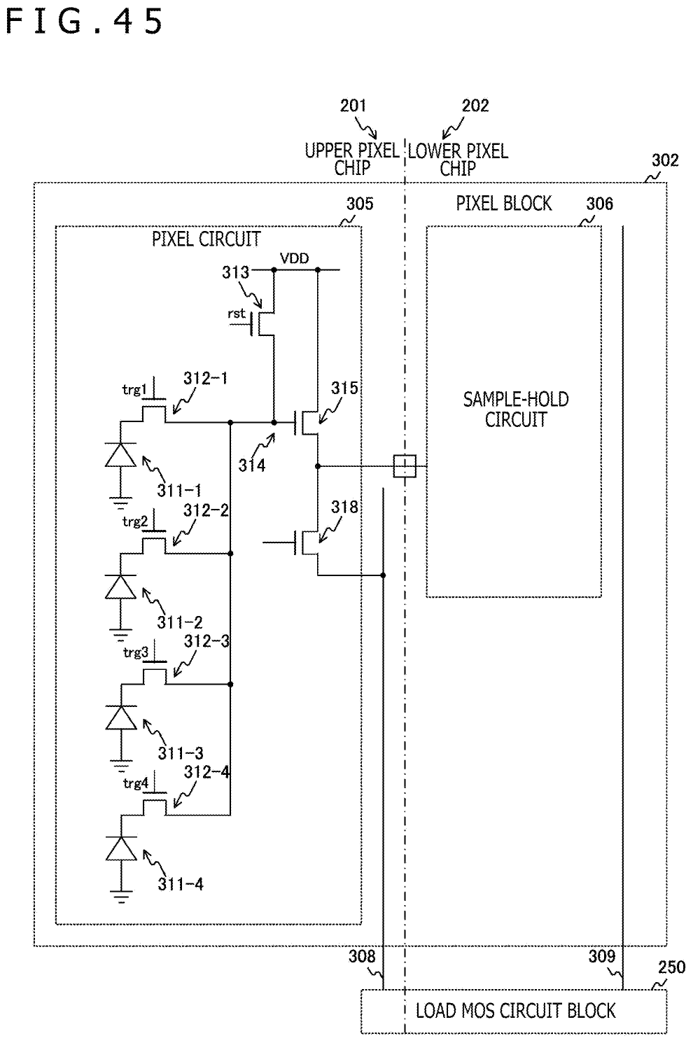

FIG. 45 is a circuit diagram depicting a configuration example of the pixel block 302 in the modification example of the eighth embodiment of the present technology. The pixel block 302 is a block having four pixels that are arrayed adjacent to each other. The pixel block 302 includes the pixel circuit 305 and the sample-hold circuit 306. Instead of the photoelectric converting element 311 and the transfer transistor 312, the pixel circuit 305 includes photoelectric converting elements 311-1 to 311-4 and transfer transistors 312-1 to 312-4. The circuit configurations of the load MOS circuit block 250 and the sample-hold circuit 306 are similar to those in the eighth embodiment. Note that the photoelectric converting elements 311-1 and 311-2 are examples of first and second photoelectric converting elements described in claims.

The transfer transistor 312-1 is configured to transfer a charge from the photoelectric converting element 311-1 to the FD 314 according to a transfer signal trg1 from the vertical scanning circuit 211. The transfer transistor 312-2 is configured to transfer a charge from the photoelectric converting element 311-2 to the FD 314 according to a transfer signal trg2 from the vertical scanning circuit 211. The transfer transistor 312-3 is configured to transfer a charge from the photoelectric converting element 311-3 to the FD 314 according to a transfer signal trg3 from the vertical scanning circuit 211. The transfer transistor 312-4 is configured to transfer a charge from the photoelectric converting element 311-4 to the FD 314 according to a transfer signal trg4 from the vertical scanning circuit 211. Note that the transfer transistors 312-1 and 312-2 are examples of first and second transfer transistors described in claims.

In the circuit configuration illustrated in the figure, the four pixels in the pixel block 302 share the FD 314 and circuits arranged downstream thereof. Note that the number of pixels to share the FD 314 and the like is not limited to four, and two pixels or eight pixels can share the FD 314 and the like.

In the global shutter mode, the transfer signals trg1 to trg4 are controlled at the same timing, and a signal obtained by adding together pixel signals of the respective four pixels is held at the sample-hold circuit 306. In contrast, in the rolling shutter mode, the transfer signals trg1 to trg4 can also be controlled at the same timing, and can alternatively be controlled at different timings. In the former control, a signal obtained by adding together pixel signals of the respective four pixels is output, and in the latter control, pixel signals of the respective four pixels are output separately. Thus, in the rolling shutter mode, image data with resolution higher than that in the global shutter mode can be captured.

Since a plurality of pixels share the FD 314 according to the modification example of the eighth embodiment of the present technology as described above, the circuit scale per pixel can be reduced as compared with a case where the FD 314 is not shared.

### 9. Ninth Embodiment

Whereas the output signal Vout1 of the pixel circuit 305 and the output signal Vout2 of the sample-hold circuit 306 are switched from one to the other in the eighth embodiment described above, this configuration requires addition of a transistor for each pixel on the upper pixel chip 201. The solid-state imaging element 200 in the ninth embodiment is different from that in the eighth embodiment in that transistors are added on the lower side and transistors on the upper side are reduced.

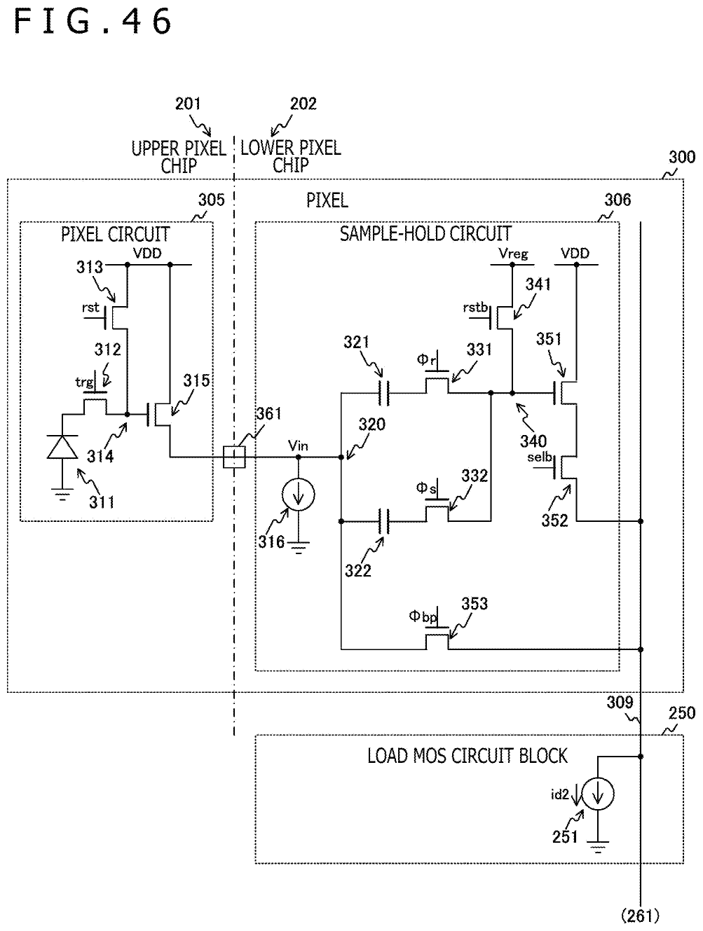

FIG. 46 is a circuit diagram depicting a configuration example of the pixel 300 in the ninth embodiment of the present technology. The pixel circuit 305 in the ninth embodiment is different from that in the eighth embodiment in that the selection transistor 318 is not arranged. In addition, the pixel array section 220 in the ninth embodiment is different from that in the eighth embodiment in that only one vertical signal line is placed for each column. The sample-hold circuit 306 in the ninth embodiment is different from that in the eighth embodiment in that the sample-hold circuit 306 further includes a bypass transistor 353. The load MOS circuit block 250 in the ninth embodiment is different from that in the eighth embodiment in that the current supply switch 252 and the changeover switch 253 are not arranged in the load MOS circuit block 250.

The bypass transistor 353 is configured to open and close a path between the upstream node 320 and the vertical signal line 309 according to a control signal Φbp from the vertical scanning circuit 211. In a case where the global shutter mode is selected, the vertical scanning circuit 211 switches the bypass transistor 353 to the OFF state.

On the other hand, in a case where the rolling shutter mode is selected, the vertical scanning circuit 211 switches the bypass transistor 353 to the ON state, and causes the upstream node 320 and the vertical signal line 309 to be connected (bypass-connected) to each other. In addition, the current source transistor 316, the selection transistors 331 and 332, and the downstream selection transistor 352 are controlled to be in the OFF state.

By the bypass transistor 353 allowing bypassing of the capacitive element 321 and the like, a low-noise fast rolling shutter operation can be realized. In addition, since the selection transistor 318 becomes unnecessary in the pixel circuit 305, the circuit scale of the upper pixel chip 201 can be reduced. In addition, since the number of vertical signal lines per column may be one, the number of wires can be reduced. Note that variations of thresholds of transistors in each of the pixel circuit 305 and the sample-hold circuit 306 are not correlated. Because of this, designing needs to be performed taking into consideration the variation directions of thresholds of transistors between the upper and lower chips, and it is necessary to note that it becomes difficult to ensure operating points in the rolling shutter mode.

The sixth embodiment in which the rolling shutter operation is performed without bypassing and the ninth embodiment are compared. Since the capacitive elements 321 and 322 are left inserted on a transfer path for a pixel signal in the rolling shutter mode in the sixth embodiment, this can be considered as a circuit configuration with DC (Direct Current) coupling. In contrast to this, since the capacitive elements 321 and 322 are bypassed in the rolling shutter mode in the ninth embodiment, this can be considered as a circuit configuration with AC (Alternating Current) coupling.

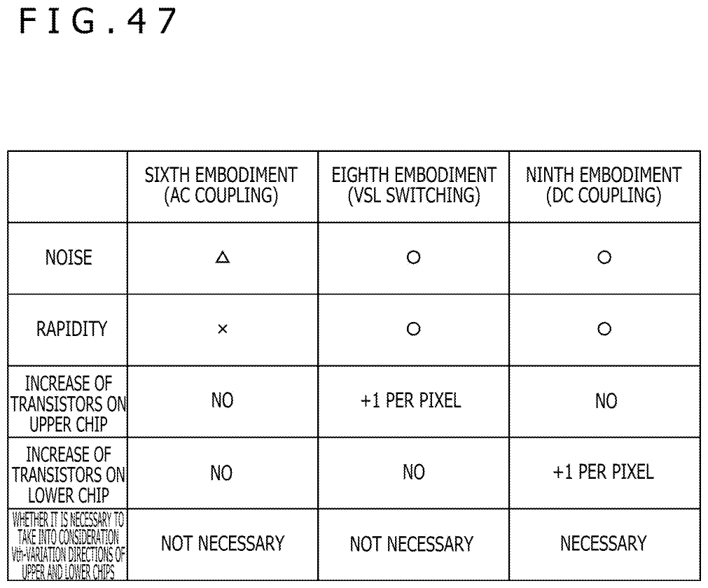

FIG. 47 is a figure for comparing the sixth, eighth, and ninth embodiments of the present technology. The circuit configuration with AC coupling in the sixth embodiment is treated as a reference circuit configuration. Note that, since comparisons are made with the eighth and ninth embodiments, it is supposed that a stacked structure is adopted also in the sixth embodiment and that the current source transistor 316 and transistors arranged downstream of it are arranged on the lower pixel chip 202.

Since the changeover switch 253 selects either of the vertical signal lines 308 and 309 in the eighth embodiment described before, a rolling shutter operation which generates less noise and is faster than that in the sixth embodiment can be realized. Note that, as compared with the sixth embodiment, it is necessary to add one transistor (selection transistor 318) per pixel on the upper chip.

Since the circuit configuration is a circuit configuration with DC coupling due to bypassing in the ninth embodiment, a rolling shutter operation which generates less noise and is faster than that in the sixth embodiment can be realized. Note that, as compared with the sixth embodiment, it is necessary to add one transistor (bypass transistor 353) per pixel on the lower chip. In addition, unlike the sixth and eighth embodiments, designing needs to be performed taking into consideration the variation directions of thresholds of transistors between the upper and lower chips.

Note that each of the second, third, fourth, fifth, and seventh embodiments can also be applied to the ninth embodiment.

Since the bypass transistor 353 bypasses the capacitive element 321 and the like in the rolling shutter mode according to the ninth embodiment of the present technology as described above, a low-noise fast rolling shutter operation can be realized.

### 10. Examples of Application to Mobile Bodies

The technology according to the present disclosure (present technology) can be applied to various products. For example, the technology according to the present disclosure may be realized as a device to be mounted on any type of a mobile body such as an automobile, an electric automobile, a hybrid electric automobile, a motorcycle, a bicycle, a personal mobility, an airplane, a drone, a ship, or a robot.

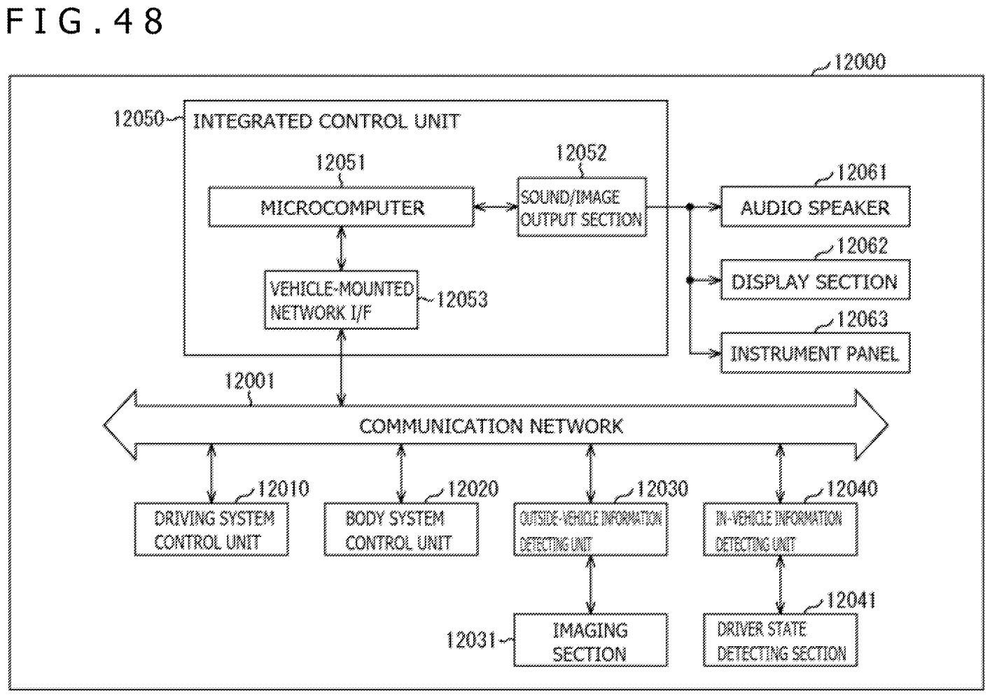

FIG. 48 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 48, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 48, an audio speaker 12061, a display section 12062, and an instrument panel 12063 are illustrated as the output device. The display section 12062 may, for example, include at least one of an on-board display and a head-up display.

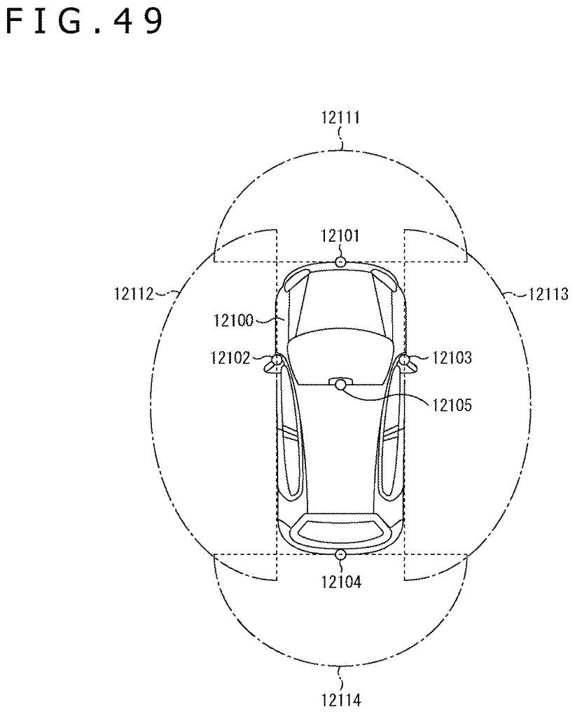

FIG. 49 is a diagram depicting an example of the installation position of the imaging section 12031.

In FIG. 49, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 49 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of vehicle control systems to which the technology according to the present disclosure can be applied has been explained thus far. The technology according to the present disclosure can be applied to the imaging section 12031 in the configuration explained above. Specifically, for example, the imaging device 100 in FIG. 1 can be applied to the imaging section 12031. By applying the technology according to the present disclosure to the imaging section 12031, captured images which have less kTC noise, and are easier to see can be obtained. Therefore, it becomes possible to mitigate the fatigue of a driver.

Note that the embodiments described above are depicted as examples for embodying the present technology, and matters in the embodiments and invention specifying matters in claims are correlated, respectively. Similarly, invention specifying matters in claims and matters in the embodiments of the present technology that are given names which are identical to those of the invention specifying matters are correlated, respectively. Note that the present technology is not limited to the embodiments but and be embodied by making various modifications to the embodiments within the scope not departing from the gist thereof.

Note that effects described in the present specification are illustrated merely as examples and are not the sole examples, and there may also be other effects.

Note that the present technology can also adopt configurations as the ones below.
(1)

A solid-state imaging element including:
a pixel circuit that outputs a pixel signal as an input signal and, in a case where a rolling shutter mode to start exposure sequentially row by row is selected, outputs the pixel signal as a first output signal;
a sample-hold circuit that holds the input signal and outputs the input signal as a second output signal in a case where a global shutter mode to start exposure simultaneously for all pixels is selected; and
a changeover switch that selects any one of the first and second output signals and outputs the selected one to an analog-to-digital converter.
(2)

The solid-state imaging element according to (1) above, further including:
a current supply switch that connects a first vertical signal line to a predetermined power supply voltage in the case where the global shutter mode is selected and that connects the first vertical signal line to the changeover switch in the case where the rolling shutter mode is selected, in which
the pixel circuit outputs the first output signal via the first vertical signal line, and
the sample-hold circuit outputs the second output signal via a second vertical signal line.
(3)

The solid-state imaging element according to claim 1, in which
the pixel circuit includes
   first and second photoelectric converting elements,
   a first transfer transistor that transfers a charge from the first photoelectric converting element to a floating diffusion layer,
   a second transfer transistor that transfers a charge from the second photoelectric converting element to the floating diffusion layer,
   a first reset transistor that initializes the floating diffusion layer,
   an upstream amplification transistor that outputs, as the input signal, a pixel signal obtained by amplifying a voltage of the floating diffusion layer to a predetermined upstream node in the sample-hold circuit, and
   a selection transistor that outputs, as the first output signal, the pixel signal according to a predetermined control signal.
(4)

The solid-state imaging element according to (1) above, in which
the pixel circuit includes
   a photoelectric converting element,
   a transfer transistor that transfers a charge from the photoelectric converting element to a floating diffusion layer,
   a first reset transistor that initializes the floating diffusion layer,
   an upstream amplification transistor that outputs, as the input signal, a pixel signal obtained by amplifying a voltage of the floating diffusion layer to a predetermined upstream node in the sample-hold circuit, and
   a selection transistor that outputs, as the first output signal, the pixel signal according to a predetermined control signal.
(5)

The solid-state imaging element according to (4) above, further including:
a vertical scanning circuit that supplies a predetermined clip level to a gate of the selection transistor when the global shutter mode is selected and a predetermined reset level is held at the sample-hold circuit.
(6)

The solid-state imaging element according to (4) or (5) above, in which
the pixel signal includes a predetermined reset level and a signal level according to an exposure amount, and
the sample-hold circuit includes
   first and second capacitive elements,
   a selecting circuit that sequentially performs control to connect one of the first and second capacitive elements to a predetermined downstream node, control to disconnect both the first and second capacitive elements from the downstream node, and control to connect the other of the first and second capacitive elements to the downstream node,
   a downstream reset transistor that initializes a level of the downstream node when both the first and second capacitive elements are disconnected from the downstream node, and
   a downstream circuit that sequentially reads out and outputs the reset level and the signal level from the first and second capacitive elements via the downstream node.
(7)

The solid-state imaging element according to (6) above, further including:
a switching section that adjusts a source voltage to be supplied to a source of the upstream amplification transistor, in which
the sample-hold circuit further includes a current source transistor connected to a drain of the upstream amplification transistor, and
the current source transistor transitions from an ON state to an OFF state after an end of an exposure period.
(8)

The solid-state imaging element according to (6) or (7) above, in which the pixel circuit further includes a discharge transistor that discharges the charge from the photoelectric converting element.
(9)

The solid-state imaging element according to any one of (6) to (8) above, further including:
a control circuit that controls a reset power supply voltage, in which
the first reset transistor initializes a voltage of a floating diffusion layer to the reset power supply voltage, and,
in a readout period in which the reset level and the signal level are read out, the control circuit makes the reset power supply voltage a voltage different from a voltage in an exposure period.
(10)

The solid-state imaging element according to any one of (6) to (9) above, further including:
a digital signal processing section that adds together a pair of consecutive frames, in which,
in an exposure period of one of the pair of frames, the sample-hold circuit causes one of the first and second capacitive elements to hold the reset level and thereafter causes the other of the first and second capacitive elements to hold the signal level, and, in an exposure period of the other of the pair of frames, the sample-hold circuit causes the other of the first and second capacitive elements to hold the reset level and thereafter causes the one of the first and second capacitive elements to hold the signal level.
(11)

The solid-state imaging element according to any one of (6) to (1) above, further including:
an analog-to-digital converter that converts the output reset level and signal level sequentially into digital signals.
(12)

The solid-state imaging element according to (11) above, in which
the analog-to-digital converter includes
   a comparator that compares a level of a vertical signal line which transfers the reset level and the signal level and a predetermined ramp signal and that outputs a comparison result, and
   a counter that performs counting with a count over a period until the comparison result is inverted and that outputs the digital signal representing the count.
(13)

The solid-state imaging element according to (12) above, in which
the comparator includes
   a comparing section that compares levels of a pair of input terminals and outputs a comparison result, and
   an input side selector that selects any one of the vertical signal line and a node with a predetermined reference voltage and connects the selected one to one of the pair of input terminals, in which
the ramp signal is input to one of the pair of input terminals.
(14)

The solid-state imaging element according to (13) above, further including:
a control section that determines whether or not illuminance is higher than a predetermined value on the basis of the comparison result and that outputs a determination result;
a CDS (Correlated Double Sampling) processing section that executes a correlated double sampling process on the digital signal; and
an output side selector that outputs any of the digital signal on which the correlated double sampling process has been executed and a digital signal with a predetermined value, on the basis of the determination result.
(15)

The solid-state imaging element according to any one of (1) to (14) above, in which
the pixel circuit is provided on a first chip, and
the sample-hold circuit is provided on a second chip.
(16)

A solid-state imaging element including:
first and second capacitive elements, each of which has one end which shares a connection to a predetermined upstream node;
a pixel circuit that sequentially generates a predetermined reset level and a signal level according to an exposure amount and outputs the predetermined reset level and the signal level to the upstream node;
a selecting circuit that connects the other end of any one of the first and second capacitive elements to a predetermined downstream node;
a downstream circuit that sequentially reads out the reset level and the signal level from the first and second capacitive elements via the downstream node and outputs the reset level and the signal level via a predetermined vertical signal line; and
a bypass transistor that connects the upstream node and the vertical signal line in a case where a rolling shutter mode to start exposure sequentially row by row is selected.
(17)

An imaging device including:
a pixel circuit that outputs a pixel signal as an input signal and, in a case where a rolling shutter mode to start exposure sequentially row by row is selected, outputs the pixel signal as a first output signal;
a sample-hold circuit that holds the input signal and outputs the input signal as a second output signal in a case where a global shutter mode to start exposure simultaneously for all pixels is selected;
a changeover switch that selects any one of the first and second output signals and outputs the selected one as an analog signal; and
an analog-to-digital converter that converts the analog signal into a digital signal.
(18)

A solid-state imaging element control method including:
an output procedure of outputting a pixel signal as an input signal and, in a case where a rolling shutter mode to start exposure sequentially row by row is selected, outputting the pixel signal as a first output signal;
a sample-hold procedure of holding the input signal and outputting the input signal as a second output signal in a case where a global shutter mode to start exposure simultaneously for all pixels is selected; and
a switch procedure of selecting any one of the first and second output signals and outputting the selected one to an analog-to-digital converter.

### REFERENCE SIGNS LIST

100: Imaging device
110: Imaging lens
120: Recording section
130: Imaging control section
200: Solid-state imaging element
201: Upper pixel chip
202: Lower pixel chip
203: Circuit chip
211: Vertical scanning circuit
212: Timing control circuit
213: DAC
220: Pixel array section
221: Upper pixel array section
222: Lower pixel array section
250: Load MOS circuit block
251: Load MOS transistor
252: Current supply switch
253: Changeover switch
260: Column signal processing circuit
261, 270: ADC
262, 290: Digital signal processing section
271: Counter
280: Comparator
281, 292: Selector
282, 283, 321, 322: Capacitive element
284, 286: Auto zero switch
285: Comparing section
291: CDS processing section
300: Pixel
301: Effective pixel
302: Pixel block
305: Pixel circuit
306: Sample-hold circuit
310: Upstream circuit
311, 311-1 to 311-4: Photoelectric converting element
312, 312-1 to 312-4: Transfer transistor
313: FD reset transistor
314: FD
315: Upstream amplification transistor
316: Current source transistor
317: Discharge transistor
318: Selection transistor
323: Upstream reset transistor
324: Upstream selection transistor
330: Selecting circuit
331, 332: Selection transistor
341: Downstream reset transistor
350: Downstream circuit
351: Downstream amplification transistor
352: Downstream selection transistor
353: Bypass transistor
361, 362: Connecting section
420: Regulator
421: Low pass filter
422: Buffer amplifier
423: Capacitive element
430: Dummy pixel
431: Reset transistor
432: FD
433: Amplification transistor
434: Current source transistor
440: Switching section
441: Inverter
442: Switching circuit
443, 444: Switch
12031: Imaging section

1. A solid-state imaging element comprising:
a pixel circuit that outputs a pixel signal as an input signal and, in a case where a rolling shutter mode to start exposure sequentially row by row is selected, outputs the pixel signal as a first output signal;
a sample-hold circuit that holds the input signal and outputs the input signal as a second output signal in a case where a global shutter mode to start exposure simultaneously for all pixels is selected; and
a changeover switch that selects any one of the first and second output signals and outputs the selected one to an analog-to-digital converter.

2. The solid-state imaging element according to claim 1, further comprising:
a current supply switch that connects a first vertical signal line to a predetermined power supply voltage in the case where the global shutter mode is selected and that connects the first vertical signal line to the changeover switch in the case where the rolling shutter mode is selected, wherein
the pixel circuit outputs the first output signal via the first vertical signal line, and
the sample-hold circuit outputs the second output signal via a second vertical signal line.

3. The solid-state imaging element according to claim 1, wherein
the pixel circuit includes
first and second photoelectric converting elements,
a first transfer transistor that transfers a charge from the first photoelectric converting element to a floating diffusion layer,
a second transfer transistor that transfers a charge from the second photoelectric converting element to the floating diffusion layer,
a first reset transistor that initializes the floating diffusion layer,
an upstream amplification transistor that outputs, as the input signal, a pixel signal obtained by amplifying a voltage of the floating diffusion layer to a predetermined upstream node in the sample-hold circuit, and
a selection transistor that outputs, as the first output signal, the pixel signal according to a predetermined control signal.

4. The solid-state imaging element according to claim 1, wherein
the pixel circuit includes
a photoelectric converting element,
a transfer transistor that transfers a charge from the photoelectric converting element to a floating diffusion layer,
a first reset transistor that initializes the floating diffusion layer,
an upstream amplification transistor that outputs, as the input signal, a pixel signal obtained by amplifying a voltage of the floating diffusion layer to a predetermined upstream node in the sample-hold circuit, and
a selection transistor that outputs, as the first output signal, the pixel signal according to a predetermined control signal.

5. The solid-state imaging element according to claim 4, further comprising:
a vertical scanning circuit that supplies a predetermined clip level to a gate of the selection transistor when the global shutter mode is selected and a predetermined reset level is held at the sample-hold circuit.

6. The solid-state imaging element according to claim 4, wherein
the pixel signal includes a predetermined reset level and a signal level according to an exposure amount, and
the sample-hold circuit includes
first and second capacitive elements,
a selecting circuit that sequentially performs control to connect one of the first and second capacitive elements to a predetermined downstream node, control to disconnect both the first and second capacitive elements from the downstream node, and control to connect the other of the first and second capacitive elements to the downstream node,
a downstream reset transistor that initializes a level of the downstream node when both the first and second capacitive elements are disconnected from the downstream node, and
a downstream circuit that sequentially reads out and outputs the reset level and the signal level from the first and second capacitive elements via the downstream node.

7. The solid-state imaging element according to claim 6, further comprising:
a switching section that adjusts a source voltage to be supplied to a source of the upstream amplification transistor, wherein
the sample-hold circuit further includes a current source transistor connected to a drain of the upstream amplification transistor, and
the current source transistor transitions from an ON state to an OFF state after an end of an exposure period.

8. The solid-state imaging element according to claim 6, wherein the pixel circuit further includes a discharge transistor that discharges the charge from the photoelectric converting element.

9. The solid-state imaging element according to claim 6, further comprising:
a control circuit that controls a reset power supply voltage, wherein
the first reset transistor initializes a voltage of a floating diffusion layer to the reset power supply voltage, and,
in a readout period in which the reset level and the signal level are read out, the control circuit makes the reset power supply voltage a voltage different from a voltage in an exposure period.

10. The solid-state imaging element according to claim 6, further comprising:
a digital signal processing section that adds together a pair of consecutive frames, wherein,
in an exposure period of one of the pair of frames, the sample-hold circuit causes one of the first and second capacitive elements to hold the reset level and thereafter causes the other of the first and second capacitive elements to hold the signal level, and, in an exposure period of the other of the pair of frames, the sample-hold circuit causes the other of the first and second capacitive elements to hold the reset level and thereafter causes the one of the first and second capacitive elements to hold the signal level.

11. The solid-state imaging element according to claim 6, further comprising:
an analog-to-digital converter that converts the output reset level and signal level sequentially into digital signals.

12. The solid-state imaging element according to claim 11, wherein
the analog-to-digital converter includes
a comparator that compares a level of a vertical signal line which transfers the reset level and the signal level and a predetermined ramp signal and that outputs a comparison result, and
a counter that performs counting with a count over a period until the comparison result is inverted and that outputs the digital signal representing the count.

13. The solid-state imaging element according to claim 12, wherein
the comparator includes
a comparing section that compares levels of a pair of input terminals and outputs a comparison result, and
an input side selector that selects any one of the vertical signal line and a node with a predetermined reference voltage and connects the selected one to one of the pair of input terminals, wherein
the ramp signal is input to one of the pair of input terminals.

14. The solid-state imaging element according to claim 13, further comprising:
a control section that determines whether or not illuminance is higher than a predetermined value on a basis of the comparison result and that outputs a determination result;
a CDS (Correlated Double Sampling) processing section that executes a correlated double sampling process on the digital signal; and
an output side selector that outputs any of the digital signal on which the correlated double sampling process has been executed and a digital signal with a predetermined value, on a basis of the determination result.

15. The solid-state imaging element according to claim 1, wherein
the pixel circuit is provided on a first chip, and
the sample-hold circuit is provided on a second chip.

16. A solid-state imaging element comprising:
first and second capacitive elements, each of which has one end which shares a connection to a predetermined upstream node;
a pixel circuit that sequentially generates a predetermined reset level and a signal level according to an exposure amount and outputs the predetermined reset level and the signal level to the upstream node;
a selecting circuit that connects the other end of any one of the first and second capacitive elements to a predetermined downstream node;
a downstream circuit that sequentially reads out the reset level and the signal level from the first and second capacitive elements via the downstream node and outputs the reset level and the signal level via a predetermined vertical signal line; and
a bypass transistor that connects the upstream node and the vertical signal line in a case where a rolling shutter mode to start exposure sequentially row by row is selected.

17. An imaging device comprising:
a pixel circuit that outputs a pixel signal as an input signal and, in a case where a rolling shutter mode to start exposure sequentially row by row is selected, outputs the pixel signal as a first output signal;
a sample-hold circuit that holds the input signal and outputs the input signal as a second output signal in a case where a global shutter mode to start exposure simultaneously for all pixels is selected;
a changeover switch that selects any one of the first and second output signals and outputs the selected one as an analog signal; and
an analog-to-digital converter that converts the analog signal into a digital signal.

18. A solid-state imaging element control method comprising:
an output procedure of outputting a pixel signal as an input signal and, in a case where a rolling shutter mode to start exposure sequentially row by row is selected, outputting the pixel signal as a first output signal;
a sample-hold procedure of holding the input signal and outputting the input signal as a second output signal in a case where a global shutter mode to start exposure simultaneously for all pixels is selected; and
a switch procedure of selecting any one of the first and second output signals and outputting the selected one to an analog-to-digital converter.
